(19) United States
(12) Patent Application Publication
(10) Pub. No.: US 2025/0126444 A1
(43) Pub. Date: Apr. 17, 2025

(54) CENTRALIZED MACHINE LEARNING MODEL CONFIGURATIONS

(71) Applicant: QUALCOMM Incorporated, San Diego, CA (US)

(72) Inventors: Juan ZHANG, Beijing (CN); Xipeng ZHU, San Diego, CA (US); Rajeev KUMAR, San Diego, CA (US); Shankar KRISHNAN, Poway, CA (US)

(21) Appl. No.: 18/832,054

(22) PCT Filed: Mar. 31, 2022
(86) PCT No.: PCT/CN2022/084320

§ 371 Date: Jul. 22, 2024

(51) Int. Cl. H04W 4/30; G06N 20/00

(52) U.S. Cl. CPC H04W 4/30; G06N 20/00

(57) ABSTRACT

Methods, systems, and devices for wireless communications are described. A UE may be configured with a machine learning model by a core network to perform analytics, training, or inferences. The UE may indicate capability information to a core network entity, including a list of machine learning models supported at the UE. A centralized core network entity may manage different machine learning models and may send information for a machine learning model to the UE, such as through another core network entity. The UE or the core network may initiate the configuration. For example, the UE may request to be configured with a machine learning model. The core network may send control signaling that indicates a configuration for the machine learning model to the UE. The UE may perform analytics based on the machine learning model.

### CROSS REFERENCE

The present Application is a 371 national phase filing of International PCT Application No. PCT/CN2022/084320 by ZHANG et al., entitled “CENTRALIZED MACHINE LEARNING MODEL CONFIGURATIONS,” filed Mar. 31, 2022, which is assigned to the assignee hereof, and which is expressly incorporated by reference in its entirety herein.

### INTRODUCTION

The following relates to wireless communications, including machine learning model management.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for wireless communications at a UE is described. The method may include transmitting, to a first core network entity, an indication of a first set of one or more machine learning models supported at the UE, receiving, from the first core network entity, control signaling indicating a configuration for a machine learning model at the UE, the first set of one or more machine learning models including the machine learning model, and performing analytics based on the machine learning model.

An apparatus for wireless communications at a UE is described. The apparatus may include a processor and memory coupled to the processor. The processor may be configured to transmit, to a first core network entity, an indication of a first set of one or more machine learning models supported at the UE, receive, from the first core network entity, control signaling indicating a configuration for a machine learning model at the UE, the first set of one or more machine learning models including the machine learning model, and perform analytics based on the machine learning model.

Another apparatus for wireless communications at a UE is described. The apparatus may include means for transmitting, to a first core network entity, an indication of a first set of one or more machine learning models supported at the UE, means for receiving, from the first core network entity, control signaling indicating a configuration for a machine learning model at the UE, the first set of one or more machine learning models including the machine learning model, and means for performing analytics based on the machine learning model.

A non-transitory computer-readable medium storing code for wireless communications at a UE is described. The code may include instructions executable by a processor to transmit, to a first core network entity, an indication of a first set of one or more machine learning models supported at the UE, receive, from the first core network entity, control signaling indicating a configuration for a machine learning model at the UE, the first set of one or more machine learning models including the machine learning model, and perform analytics based on the machine learning model.

Some examples of the method, apparatuses, and non-transitory computer-readable medium described herein may further include operations, features, means, or instructions for transmitting, to the first core network entity, a request for the machine learning model, where receiving the control signaling includes receiving the control signaling in response to transmitting the request.

In some examples of the method, apparatuses, and non-transitory computer-readable medium described herein, transmitting the request may include operations, features, means, or instructions for transmitting a service request message, where receiving the control signaling includes receiving the control signaling via a service response message.

In some examples of the method, apparatuses, and non-transitory computer-readable medium described herein, the request includes an identifier for the machine learning model, a network slice identifier, or both.

Some examples of the method, apparatuses, and non-transitory computer-readable medium described herein may further include operations, features, means, or instructions for transmitting, to the first core network entity, a completion message based on the control signaling indicating the configuration for the machine learning model at the UE.

In some examples of the method, apparatuses, and non-transitory computer-readable medium described herein, receiving the control signaling may include operations, features, means, or instructions for receiving the control signaling indicating the configuration for the machine learning model, the control signaling indicating a machine learning model file address, a machine learning model training request, a machine learning model inference request, a machine learning model identifier, a machine learning model location, a machine learning model version, a duration of time for performing the analytics, an activation event for reporting the analytics, or any combination thereof.

In some examples of the method, apparatuses, and non-transitory computer-readable medium described herein, receiving the control signaling may include operations, features, means, or instructions for receiving one or more parameters for the machine learning model; and where performing the analytics includes performing the analytics based on the one or more parameters.

Some examples of the method, apparatuses, and non-transitory computer-readable medium described herein may further include operations, features, means, or instructions for obtaining the machine learning model from a core network based on an address indicated via the control signaling.

Some examples of the method, apparatuses, and non-transitory computer-readable medium described herein may further include operations, features, means, or instructions for transmitting a non-access stratum (NAS) message to the first core network entity including information determined from performing the analytics based on the machine learning model.

In some examples of the method, apparatuses, and non-transitory computer-readable medium described herein, receiving the control signaling may include operations, features, means, or instructions for receiving a NAS message that may be configured according to a core network centralized entity container, the NAS message indicating the configuration for the machine learning model at the UE.

In some examples of the method, apparatuses, and non-transitory computer-readable medium described herein, the first core network entity may be an access and mobility management function (AMF) entity.

A method for wireless communications is described. The method may include obtaining an indication of a first set of one or more machine learning models supported at a UE, obtaining, from a second core network entity, control signaling configured according to the second core network entity, the control signaling indicating a configuration for a machine learning model from the first set of one or more machine learning models at the UE, and outputting a NAS message including the control signaling configured according to the second core network entity.

An apparatus for wireless communications is described. The apparatus may include a processor and memory coupled to the processor. The processor may be configured to obtain an indication of a first set of one or more machine learning models supported at a UE, obtain, from a second core network entity, control signaling configured according to the second core network entity, the control signaling indicating a configuration for a machine learning model from the first set of one or more machine learning models at the UE, and output a NAS message including the control signaling configured according to the second core network entity.

Another apparatus for wireless communications is described. The apparatus may include means for obtaining an indication of a first set of one or more machine learning models supported at a UE, means for obtaining, from a second core network entity, control signaling configured according to the second core network entity, the control signaling indicating a configuration for a machine learning model from the first set of one or more machine learning models at the UE, and means for outputting a NAS message including the control signaling configured according to the second core network entity.

A non-transitory computer-readable medium storing code for wireless communications is described. The code may include instructions executable by a processor to obtain an indication of a first set of one or more machine learning models supported at a UE, obtain, from a second core network entity, control signaling configured according to the second core network entity, the control signaling indicating a configuration for a machine learning model from the first set of one or more machine learning models at the UE, and output a NAS message including the control signaling configured according to the second core network entity.

Some examples of the method, apparatuses, and non-transitory computer-readable medium described herein may further include operations, features, means, or instructions for obtaining a request for the machine learning model, outputting, to the second core network entity, an indication of the request for the machine learning model; and where obtaining the control signaling includes, and obtaining the control signaling based on the indication.

Some examples of the method, apparatuses, and non-transitory computer-readable medium described herein may further include operations, features, means, or instructions for outputting, to a third core network entity, a discovery request for the second core network entity and obtaining, from the third core network entity, an identifier for the second core network entity based on the discovery request.

In some examples of the method, apparatuses, and non-transitory computer-readable medium described herein, the request includes an identifier for the machine learning model, a network slice identifier, or both.

Some examples of the method, apparatuses, and non-transitory computer-readable medium described herein may further include operations, features, means, or instructions for obtaining, from the second core network entity, a request for one or more UEs to perform analytics based on the machine learning model; and where outputting the NAS message includes outputting the NAS message to the UE based on the request.

Some examples of the method, apparatuses, and non-transitory computer-readable medium described herein may further include operations, features, means, or instructions for outputting, to the second core network entity, one or more identifiers for a set of one or more UEs associated with a first core network entity that support the machine learning model, the set of UEs including at least the UE.

In some examples of the method, apparatuses, and non-transitory computer-readable medium described herein, the request for the one or more UEs to perform analytics includes one or more UE identifiers, one or more registration area lists, one or more network slice identifiers, or any combination thereof, associated with the one or more UEs.

Some examples of the method, apparatuses, and non-transitory computer-readable medium described herein may further include operations, features, means, or instructions for identifying the one or more UEs including at least the UE based on the request.

In some examples of the method, apparatuses, and non-transitory computer-readable medium described herein, outputting the control signaling may include operations, features, means, or instructions for outputting the NAS message including the control signaling indicating a machine learning model file address, a machine learning model training request, a machine learning model inference request, a machine learning model identifier, a machine learning model location, a machine learning model version, a duration of time for performing analytics, an activation event for reporting the analytics, one or more parameters for the machine learning model, or any combination thereof.

Some examples of the method, apparatuses, and non-transitory computer-readable medium described herein may further include operations, features, means, or instructions for obtaining a completion message in response to the NAS message and outputting the completion message to the second core network entity.

A method for wireless communications at a second core network entity is described. The method may include identifying a UE that supports a machine learning model being configured at the UE and transmitting, to a first core network entity, control signaling configured according to the second core network entity, the control signaling to configure the machine learning model at the UE.

An apparatus for wireless communications at a second core network entity is described. The apparatus may include a processor and memory coupled to the processor. The processor may be configured to identify a UE that supports a machine learning model being configured at the UE and transmit, to a first core network entity, control signaling configured according to the second core network entity, the control signaling to indicate a configuration for the machine learning model to the UE.

Another apparatus for wireless communications at a second core network entity is described. The apparatus may include means for identifying a UE that supports a machine learning model being configured at the UE and means for transmitting, to a first core network entity, control signaling configured according to the second core network entity, the control signaling to indicate a configuration for the machine learning model to the UE.

A non-transitory computer-readable medium storing code for wireless communications at a second core network entity is described. The code may include instructions executable by a processor to identify a UE that supports a machine learning model being configured at the UE and transmit, to a first core network entity, control signaling configured according to the second core network entity, the control signaling to indicate a configuration for the machine learning model to the UE.

Some examples of the method, apparatuses, and non-transitory computer-readable medium described herein may further include operations, features, means, or instructions for receiving, from the first core network entity, an indication of a request from the UE for the machine learning model to be configured at the UE, where the UE may be identified based on the indication of the request.

In some examples of the method, apparatuses, and non-transitory computer-readable medium described herein, receiving the indication may include operations, features, means, or instructions for receiving a NAS message from the UE via the first core network entity, the NAS message including the request.

In some examples of the method, apparatuses, and non-transitory computer-readable medium described herein, the request includes an identifier for the machine learning model, a network slice identifier, or both.

Some examples of the method, apparatuses, and non-transitory computer-readable medium described herein may further include operations, features, means, or instructions for receiving, from another network entity, a request for one or more UEs to perform analytics based on the machine learning model.

In some examples of the method, apparatuses, and non-transitory computer-readable medium described herein, identifying the UE may include operations, features, means, or instructions for transmitting, to one or more network entities including at least the second core network entity, a request message for the one or more network entities to report UE identifiers for UEs that support the machine learning model and receiving, from at least the second core network entity, a response message indicating a set of UEs including at least the UE.

In some examples of the method, apparatuses, and non-transitory computer-readable medium described herein, the request message includes one or more registration area lists, one or more network slice identifiers, an identifier for the machine learning model.

Some examples of the method, apparatuses, and non-transitory computer-readable medium described herein may further include operations, features, means, or instructions for transmitting, to a third core network entity, a discovery request for the one or more network entities, the discovery request including one or more registration area lists or one or more network slice identifiers, or both and receiving, from the third core network entity, a discovery response message indicating the one or more network entities including at least the second core network entity, where the one or more network entities correspond to the one or more registration area lists or the one or more network slice identifiers, or both.

In some examples of the method, apparatuses, and non-transitory computer-readable medium described herein, the request for the one or more UEs to perform the analytics includes one or more UE identifiers for the one or more UEs, a UE group identifier, or both, where the UE may be identified based on the request.

In some examples of the method, apparatuses, and non-transitory computer-readable medium described herein, transmitting the control signaling may include operations, features, means, or instructions for transmitting the control signaling indicating a machine learning model file address, a machine learning model training request, a machine learning model inference request, a machine learning model identifier, a machine learning model location, a machine learning model version, a duration of time for performing analytics, an activation event for reporting the analytics, one or more parameters for the machine learning model, or any combination thereof.

Some examples of the method, apparatuses, and non-transitory computer-readable medium described herein may further include operations, features, means, or instructions for receiving, from the UE via the first core network entity, a NAS message including information determined at the UE by performing analytics based on the machine learning model.

### BRIEF DESCRIPTION OF THE DRAWINGS

FIG. 1 illustrates an example of a wireless communications system that supports centralized machine learning model configurations in accordance with aspects of the present disclosure.

FIG. 2 illustrates an example of a wireless communications system that supports centralized machine learning model configurations in accordance with aspects of the present disclosure.

FIG. 3 illustrates an example of a capability indication procedure that supports centralized machine learning model configurations in accordance with aspects of the present disclosure.

FIG. 4 illustrates an example of a network-initiated machine learning model configuration that supports centralized machine learning model configurations in accordance with aspects of the present disclosure.

FIG. 5 illustrates an example of a UE-initiated machine learning model configuration that supports centralized machine learning model configurations in accordance with aspects of the present disclosure.

FIG. 6 illustrates an example of a machine learning process that supports centralized machine learning model configurations in accordance with aspects of the present disclosure.

FIGS. 7 and 8 show block diagrams of devices that support centralized machine learning model configurations in accordance with aspects of the present disclosure.

FIG. 9 shows a block diagram of a communications manager that supports centralized machine learning model configurations in accordance with aspects of the present disclosure.

FIG. 10 shows a diagram of a system including a device that supports centralized machine learning model configurations in accordance with aspects of the present disclosure.

FIGS. 11 and 12 show block diagrams of devices that support centralized machine learning model configurations in accordance with aspects of the present disclosure.

FIG. 13 shows a block diagram of a communications manager that supports centralized machine learning model configurations in accordance with aspects of the present disclosure.

FIG. 14 shows a diagram of a system including a device that supports centralized machine learning model configurations in accordance with aspects of the present disclosure.

FIGS. 15 through 19 show flowcharts illustrating methods that support centralized machine learning model configurations in accordance with aspects of the present disclosure.

### DETAILED DESCRIPTION

A core network of a wireless communications system may train a machine learning model to perform analytics, such as network optimizations and inferences. A UE in the wireless communications system may also support performing analytics based on a machine learning model. For example, the core network may configure the UE with a trained machine learning model, and the UE may perform analytics using the trained machine learning model. The UE may obtain inference results from the trained machine learning model, and the inference results may be used for local optimizations at the UE or reported to the core network for core network optimizations.

The present disclosure provides techniques for configuring a machine learning model at a UE using a centralized architecture with a centralized core network entity. A centralized core network entity may manage, store, or support one or more machine learning models associated with various functionalities of the core network. For example, the centralized core network entity may manage machine learning models associated with mobility management, session management, policy-related management, and the like. In one example, the centralized entity may configure a UE with a machine learning model via NAS signaling through another network entity, such as an AMF entity, and the UE may perform analytics using the machine learning model. In some cases, to support the centralized architecture techniques, a UE may report capability information to a serving AMF entity, and the AMF entity may communicate signaling between the UE and the centralized core network entity. For example, the centralized core network entity may support and manage artificial intelligence or machine learning techniques, but there may not be a direct link between the UE and the centralized core network entity, as an interface between the UE and the core network may be terminated at the AMF entity. Therefore, the UE may communicate with the centralized core network entity through the AMF entity, such as via NAS signaling which is transmitted to and then forwarded by the AMF entity. For example, the UE may send a NAS request to the AMF entity, and the AMF entity may send the request to the centralized core network entity. Similarly, the centralized core network entity may send configuration signaling to the AMF entity, and the AMF entity forwards the configuration signaling to the UE via a downlink NAS message.

Either the UE or the core network may initiate the procedure to configure the UE with a machine learning model. In some cases, the UE may initiate the procedure by transmitting a request for a machine learning model to an AMF entity, which may forward the request to the centralized core network entity. The AMF entity may identify, or discover, a centralized core network entity which manages the requested machine learning model and send the request to the centralized core network entity. The centralized core network entity may send control signaling to configure the UE with the machine learning model to the AMF entity, and the AMF entity may send the control signaling (e.g., forward a NAS message) to the UE to configure the UE with the machine learning model, or to indicate a configuration for the machine learning model to the UE. In some cases, the centralized core network entity may receive a request, from another network entity or a consumer, for a UE to perform analytics using a machine learning model. The centralized core network entity may identify, or discover, an AMF entity which serves one or more UEs having the capability to support the requested machine learning model, and the centralized core network entity may configure the identified one or more UEs with the machine learning model via the AMF entity. The centralized core network entity may receive a request to obtain analytics from one or more specific UEs, a group of UEs, or for a network slice.

In some cases, the UE may obtain a machine learning model from the core network. For example, the UE may receive the control signaling configuring or indicating the machine learning model. The control signaling may include, for example, an address or location for the machine learning model (e.g., a Uniform Resource Locator (URL) or a Fully Qualified Domain Name (FQDN)), and the UE may obtain the machine learning model from the core network via the address or the location for the machine learning model.

The UE may perform analytics based on the machine learning model.

Performing the analytics may enable some optimizations at the UE or at the core network. For example, the UE may request to perform the analytics to achieve UE optimizations based on inferences determined from the machine learning model. In some cases, the UE may use the machine learning model for network load analytic, and the UE may request for the network to provide the machine learning model or an analytics result. The UE may perform analytics using the machine learning model or use the analytics results to perform network selection to a network with a low network load, increasing throughput and reducing latency and network load bearing. For example, performing analytics at the UE or training a machine learning model at the UE may provide more information for performing network selection or network load management than performing analytics or inferences at the network-side alone. Additionally, or alternatively, a core network entity or a consumer may request for the UE to perform analytics and report information obtained from performing the analytics, which may enable optimizations at the core network or the core network entity based on the reported information. For example, an application client may request for the UE to perform analytics using a machine learning model, and the UE may report analytics information from the machine learning model. The application client may use the reported information for, for example, split rendering, reducing processing power at the UE or network, or both.

A system which does not support performing machine learning model training or analytics at a UE perform local device management or network management (e.g., network load management, split rendering for virtual reality, extended reality, or augmented reality techniques, etc.) based on information or inferences obtained at the network (e.g., network-side inferences and analytics). However, by implementing techniques described herein, a UE or a network entity, or both, may perform local device management or network management based on inferences or analytics performed at both the UE and the network entity, which may provide more information for the UE or network entity, or both, to perform more optimized device or network management.

For example, a UE may use network load analytics to predict a network load for different radio access technologies (RATs) (e.g. 4G or 5G) and register to a RAT based on the network load prediction. In another example, for a specific protocol data unit (PDU) session, a UE may determine to establish the PDU session via different access technologies based on the network load prediction. In another example, by implementing these techniques, the UE may provide the network load prediction analytics to a UE application client, and the application client can determine whether to initiate a high bit rate data transmission. The network may provide a UE list to a requesting entity, node, or consumer based on a request from the entity, node, or consumer. For example, an application function may request the UE list within a specific location, and the network may request for UEs to provide network load predictions and provide the UE list to the application function. A UE may select a network or RAT based on the network load predictions with a lower load, which may provide higher quality communications or lower latency communications for the UE.

Aspects of the disclosure are initially described in the context of wireless communications systems. Aspects of the disclosure are further illustrated by and described with reference to apparatus diagrams, system diagrams, and flowcharts that relate to centralized machine learning model configurations.

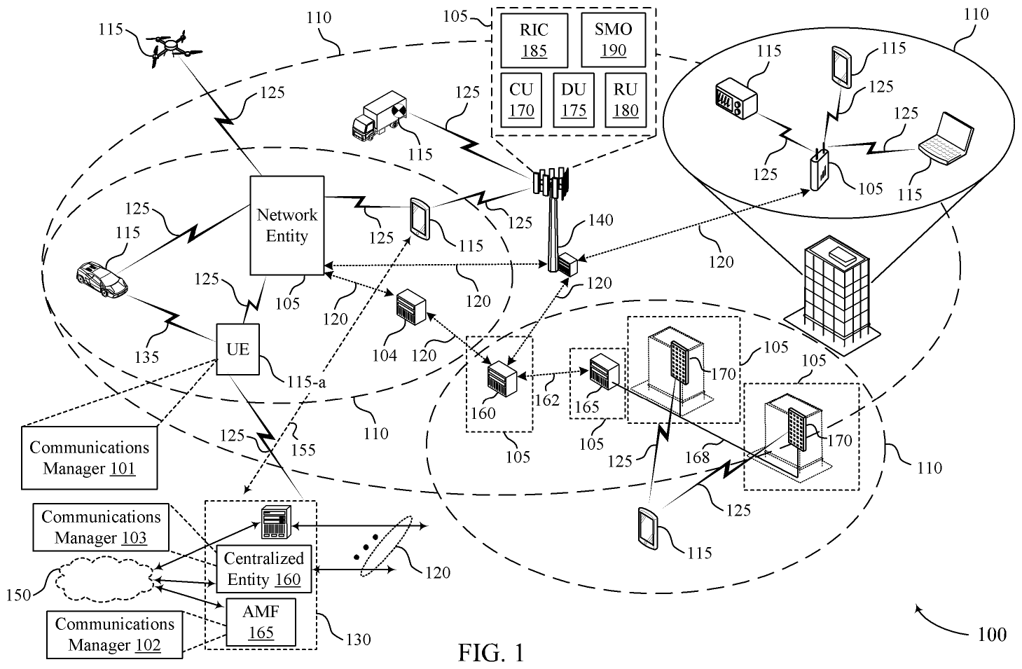

FIG. 1 illustrates an example of a wireless communications system 100 that supports distributed machine learning model configurations in accordance with aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 170, a distributed unit (DU) 175, a radio unit (RU) 180, a RAN Intelligent Controller (RIC) 185 (e.g., a Near-Real Time RIC (Near-RT RIC), a Non-Real Time RIC (Non-RT RIC)), a Service Management and Orchestration (SMO) 190 system, or any combination thereof. An RU 180 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 170, a DU 175, and an RU 185 is flexible and may support different functionalities depending upon which functions (e.g., network layer functions, protocol layer functions, baseband functions, RF functions, and any combinations thereof) are performed at a CU 170, a DU 175, or an RU 185. For example, a functional split of a protocol stack may be employed between a CU 170 and a DU 175 such that the CU 170 may support one or more layers of the protocol stack and the DU 175 may support one or more different layers of the protocol stack. In some examples, the CU 170 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 170 may be connected to one or more DUs 175 or RUs 180, and the one or more DUs 175 or RUs 180 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 170. Additionally, or alternatively, a functional split of the protocol stack may be employed between a DU 175 and an RU 180 such that the DU 175 may support one or more layers of the protocol stack and the RU 180 may support one or more different layers of the protocol stack. The DU 175 may support one or multiple different cells (e.g., via one or more RUs 180). In some cases, a functional split between a CU 170 and a DU 175, or between a DU 175 and an RU 180 may be within a protocol layer (e.g., some functions for a protocol layer may be performed by one of a CU 170, a DU 175, or an RU 180, while other functions of the protocol layer are performed by a different one of the CU 170, the DU 175, or the RU 180). A CU 170 may be functionally split further into CU control plane (CU-CP) and CU user plane (CU-UP) functions. A CU 170 may be connected to one or more DUs 175 via a midhaul communication link 162 (e.g., F1, F1-c, F1-u), and a DU 175 may be connected to one or more RUs 180 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 175 or one or more RUs 180 may be partially controlled by one or more CUs 170 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 175 of a coupled IAB donor. An IAB-MT may include an independent set of antennas for relay of communications with UEs 115, or may share the same antennas (e.g., of an RU 180) of an IAB node 104 used for access via the DU 175 of the IAB node 104 (e.g., referred to as virtual IAB-MT (vIAB-MT)). In some examples, the IAB nodes 104 may include DUs 175 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 170 and at least one DU 175 (e.g., and RU 180), in which case the CU 170 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 170 may communicate with the core network over an interface, which may be an example of a portion of backhaul link, and may communicate with other CUs 170 (e.g., a CU 170 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 175 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 175) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 170 with a wired or wireless connection (e.g., a backhaul communication link 120) to the core network 130 and may act as parent node to IAB nodes 104. For example, the DU 175 of IAB donor may relay transmissions to UEs 115 through IAB nodes 104, and may directly signal transmissions to a UE 115. The CU 170 of IAB donor may signal communication link establishment via an F1 interface to IAB nodes 104, and the IAB nodes 104 may schedule transmissions (e.g., transmissions to the UEs 115 relayed from the IAB donor) through the DUs 175. That is, data may be relayed to and from IAB nodes 104 via signaling over an NR Uu interface to MT of the IAB node 104. Communications with IAB node 104 may be scheduled by a DU 175 of IAB donor and communications with IAB node 104 may be scheduled by DU 175 of IAB node 104.

In the case of the techniques described herein applied in the context of a disaggregated RAN architecture, one or more components of the disaggregated RAN architecture may be configured to support centralized machine learning model configurations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 175, CUs 170, RUs 180, RIC 185, SMO 190).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 170, a DU 175, a RU 180) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 180) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different RATs.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 180), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 180) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC), 5G core (5GC), or other generations or systems, which may include at least one control plane entity that manages access and mobility (e.g., a mobility management entity (MME), an AMF entity 165) and at least one user plane entity that routes packets or interconnects to external networks (e.g., a serving gateway (S-GW), a Packet Data Network (PDN) gateway (P-GW), or a user plane function (UPF)). The control plane entity may manage NAS functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 180), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 180) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 180) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 180), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

The present disclosure provides techniques for configuring a machine learning model at a UE 115 using a centralized architecture with a centralized core network entity 160. A centralized core network entity 160 may manage, store, or support one or more machine learning models associated with various functionalities of the core network 130. In some cases, a 5G networks data analytics function may be an example of the centralized core network entity 160. The centralized core network entity 160 may coordinate or use artificial intelligence or machine learning operation in the wireless communications system 100, such as for the core network 130, the RAN, the UEs 115, or any combination thereof. In some examples the centralized core network entity 160 may be an example of or provide a core network interface for artificial intelligence operation, machine learning operation, or both. In some cases, the centralized core network entity 160 may be a network entity dedicated to machine learning model configuration and management.

For example, the centralized core network entity 160 may manage machine learning models associated with mobility management, session management, and the like. The centralized core network entity 160 may configure a UE 115 with a machine learning model via NAS signaling through another network entity, such as an AMF entity 165, and the UE 115 may perform analytics using the machine learning model. In some cases, to support the centralized architecture techniques, a UE 115 may report capability information to a serving AMF entity 165, and the AMF entity 165 may communicate signaling between the UE 115 and the centralized core network entity 160.

In some examples, the AMF entity 165 may not support artificial intelligence or machine learning techniques, but there may not be a direct link between the UE and the centralized core network entity for machine learning, as an interface between the UE and the core network may be terminated at the AMF entity. Therefore, the UE may communicate with the centralized core network entity through the AMF entity, such as via NAS signaling which is transmitted to and then forwarded by the AMF entity. For example, the UE may send a NAS request to the AMF entity, and the AMF entity may send the request to the centralized core network entity. Similarly, the centralized core network entity may send configuration signaling to the AMF entity, and the AMF entity forwards the configuration signaling to the UE via a downlink NAS message.

Either the UE 115 or the core network 130 may initiate the procedure to configure the UE 115 with a machine learning model. In some cases, the UE 115 may initiate the procedure by transmitting a request for a machine learning model to an AMF entity 165. The AMF entity 165 may identify, or discover, a centralized core network entity 160 which manages the requested machine learning model and send the request to the centralized core network entity 160. The centralized core network entity 160 may send control signaling to configure the UE 115 with the machine learning model to the AMF entity 165, and the AMF entity 165 may send (e.g., forward a NAS message) the control signaling to the UE 115 to configure the UE 115 with the machine learning model. In some cases, the centralized core network entity 160 may receive a request, from another network entity or a consumer, for a UE 115 to perform analytics using a machine learning model.

The centralized core network entity 160 may identify, or discover, an AMF entity 165 which serves one or more UEs 115 that have the capability to support the requested machine learning model. For example, the UE 115 may send a supported machine learning model identifier to the AMF entity 165 during a registration procedure, and the AMF entity 165 may store a capability of the UE 115 to support a machine learning model associated with the machine learning model identifier as part of a UE context. The centralized core network entity 160 may select UEs 115 which support the ML model based on a request for one or more UEs 115 to perform analytics or inferences using the machine learning model, and the centralized core network entity 160 may send a request to the AMF entity 160 with the machine learning model identifier. The AMF entity 160 may respond to the centralized core network entity 160, indicating which UEs 115 support the identified machine model based on the stored UE context. The centralized core network entity 160 may configure the identified one or more UEs 115 with the machine learning model via the AMF entity 165, such as via NAS signaling which is transmitted to the one or more UEs 115 via the AMF entity 165. The centralized core network entity 160 may receive a request to obtain analytics from one or more specific UEs 115, a group of UEs 115, or for a network slice.

In some cases, the UE 115 may obtain a machine learning model from the core network 130. For example, the UE 115 may receive the control signaling configuring or indicating the machine learning model. The control signaling may include, for example, an address or location for the machine learning model (e.g., a URL or an FQDN), and the UE 115 may obtain the machine learning model from the core network 130 via the address or the location for the machine learning model. For example, the machine learning may be a file with many data packets. In some examples, instead of the centralized core network entity 160 providing the machine learning model to UE 115 directly via signaling (e.g., as this may bring significant overhead to the core network), the centralized core network entity 160 may indicate send the machine learning model configuration to UE 115 including a machine learning model file download address. The UE may download the machine learning model via user plane using the machine learning model file download address.

In some examples, a UE 115-a may include a communications manager 101 that is configured to support one or more aspects of the techniques for centralized machine learning model configurations described herein. For example, the communications manager 101 may be configured to support the UE 115-a transmitting, to a first core network entity such as the AMF entity 165, an indication of a first set of one or more machine learning models supported at the UE 115-a. In some examples, the communications manager 102 may be configured to support the UE 115-a receiving, from the AMF entity 165, control signaling indicating a configuration for a machine learning model at the UE 115-a. The first set of one or more machine learning models may include the machine learning model. In some examples, the communications manager 101 may be configured to support the UE 115-a performing analytics based on the machine learning model.

In some examples, the AMF entity 165 may include a communications manager 102 that is configured to support one or more aspects of the techniques for centralized machine learning model configurations described herein. For example, the communications manager 102 may be configured to support the AMF entity 165 obtaining an indication of a first set of one or more machine learning models supported at a UE 115. In some examples, the indication may be obtained or received from a UE 115 such as the UE 115-a. In some examples, the communications manager 102 may be configured to support the AMF entity 165 obtaining, from a second core network entity such as the centralized core network entity 160, control signaling configured according to the second core network entity, the control signaling indicating a configuration for a machine learning model from the first set of one or more machine learning models. In some examples, the communications manager 102 may be configured to support the AMF entity 165 to output a NAS message including the control signaling configured according to the second core network entity.

In some examples, a centralized core network entity 160 may include a communications manager 103 that is configured to support one or more aspects of the techniques for centralized machine learning model configurations described herein. For example, the communications manager 103 may be configured to support the centralized core network entity 160 identifying a UE 115, such as the UE 115-a, that supports a machine learning model being configured at the UE 115. In some examples, the communications manager 103 may be configured to support the centralized core network entity 160 outputting, to a first core network entity (e.g., the AMF entity 165), control signaling configured according to the centralized core network entity 160, the control signaling to indicate a configuration for the machine learning model to the UE 115.

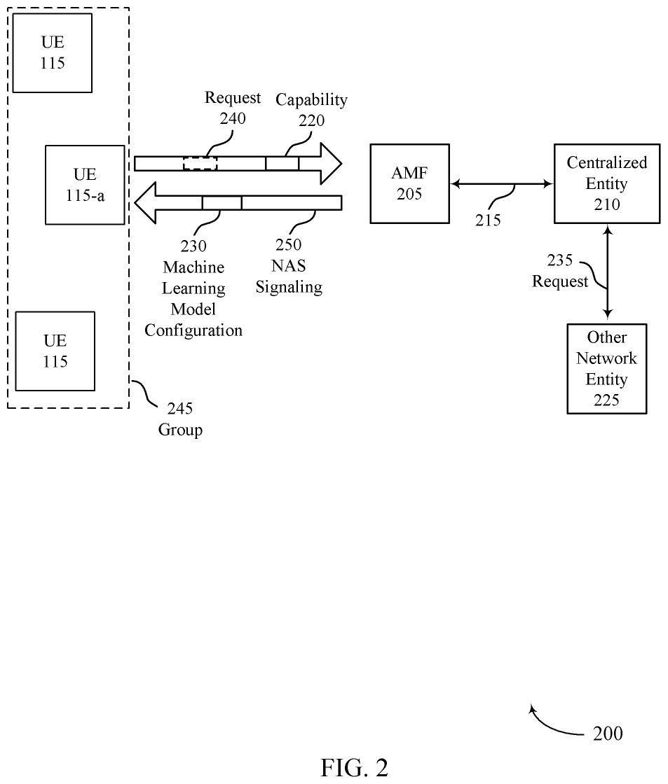

FIG. 2 illustrates an example of a wireless communications system 200 that supports centralized machine learning model configurations in accordance with aspects of the present disclosure.

The wireless communications system 200 may include a UE 115-a, which may be an example of a UE 115 as described with reference to FIG. 1. The wireless communications system 200 may include one or more entities of a core network, such as an AMF entity 205, a centralized core network entity 210, or both. In some cases, wireless communications system 200 may include another network entity 225, which may be an example of another network entity, the AMF entity 205, a session management function (SMF) entity, a consumer in the wireless communications system 200, or any combination thereof. In some cases, the UE 115-a may communicate with the AMF entity 205 and the centralized core network entity 210 directly. Additionally, or alternatively, the UE 115-a may communicate with the AMF entity 205 and the centralized core network entity 210 by communicating NAS signaling via a network entity 105. In some cases, the UE 115-a may communicate with the centralized core network entity 210 through the AMF entity 205, such as by transmitting or receiving NAS signaling configured according to the centralized core network entity 210, which is conveyed via the AMF entity 205 to or from the centralized core network entity 210. In some cases, the AMF entity 205 and the centralized core network entity 210 may communicate via a network link 215.

A core network of the wireless communications system 200 may train a machine learning model to perform analytics, such as network optimizations and inferences. UEs 115 in the wireless communications system 200, such as the UE 115-a, may also support performing analytics using a machine learning model. The wireless communications system 200 may implement an example configuration of a centralized architecture for configuring UEs 115, such as the UE 115-a, with a machine learning model.

For a centralized architecture or a centralized configuration, the centralized core network entity 210 may manage, store, or support one or more machine learning models associated with functionality of the core network entity. For example, the centralized core network entity 210 may manage machine learning models associated with mobility management, session management, and the like. For example, the centralized core network entity 210 may have the function to support machine learning model training, data collection and artificial intelligence inference, and artificial intelligence analytics data exposure. The centralized core network entity 210 may transmit a machine learning model configuration 230 to a UE 115, such as the UE 115-a, indicating a machine learning model. The machine learning configuration 230 may be transmitted via NAS signaling 250 through another network entity, such as the AMF entity 205, and the UE 115-a may perform analytics using the machine learning model.

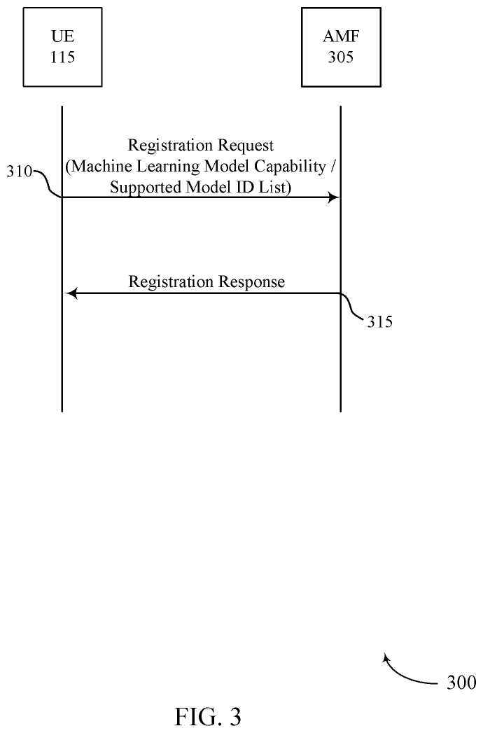

In some cases, to support the centralized architecture techniques, the UE 115-a may report capability information to a serving AMF entity, such as the AMF entity 205. For example, the UE 115-a may send a capability message 220 to the AMF entity 205, indicating identifiers of machine learning models which are supported by the UE 115-a. An example of a UE and network capability exchange is described in more detail with reference to FIG. 3.

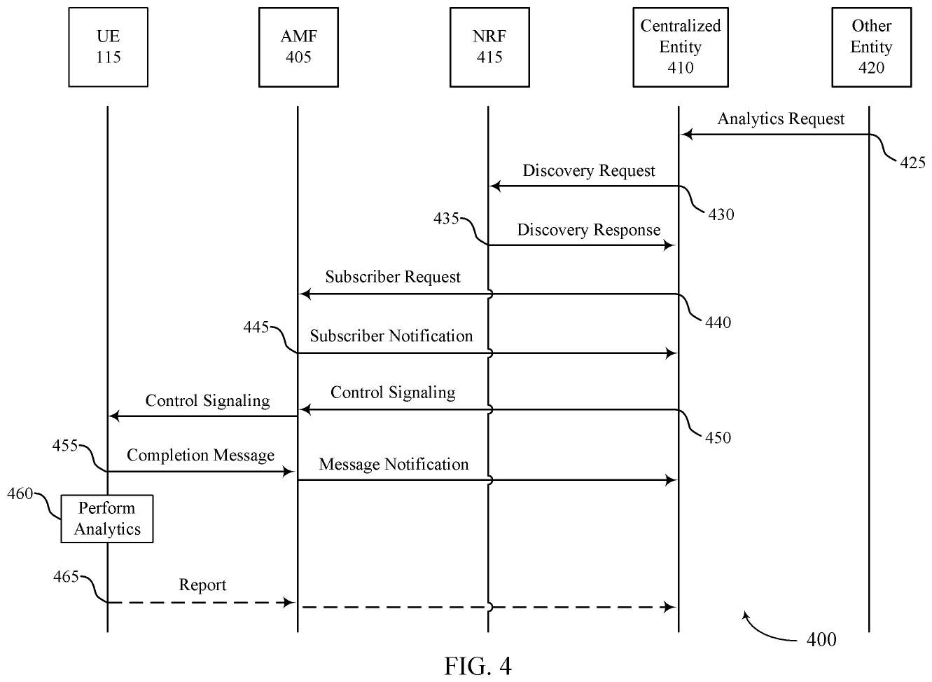

Either the UE 115-a or the core network may initiate the procedure to configure the UE 115-a with a machine learning model. In some cases, the centralized core network entity 210 may receive a request 235, from another network entity or a consumer, for a UE 115 to perform analytics using a machine learning model. The consumer may be, for example, another network entity, such as the AMF entity 205, an SMF entity, a policy and charging rules function (PCF) entity, an operations, administration, and maintenance (OAM) entity, or an application function entity, which may send an analytics request for different uses. The centralized core network entity 210 may identify, or discover, an AMF entity, such as the AMF entity 205, which serves one or more UEs 115 that have capability to support the requested machine learning model, such as the UE 115-a. The centralized core network entity 210 may configure the identified one or more UEs 115 with the machine learning model via the AMF entity 205. The centralized core network entity 210 may receive the request 235 to obtain analytics from one or more specific UEs 115, a group 245 of UEs 115, or for a network slice. The group 245 of UEs 115 may, for example, correspond to UEs 115 with a common group identifier, in a common network slice, in a common registration area, having common capabilities, or any combination thereof. In some examples, the group 245 of UEs 115 may be identified based on a group identifier, and the centralized core network entity 210 may identify a subscriber permanent identifier (SUPI) for the UEs 115 in the group 245 or for the group 245. In some cases, to discover the UEs 115 having the capability to support the requested machine learning model, the centralized core network entity 210 may send a discovery request message to a network repository function (NRF) entity. The NRF entity may send a discovery response message to the centralized core network entity 210, indicating or identifying one or more AMF entities that serve UEs 115 which support the requested machine learning model. An example of a core network-initiated machine learning model configuration is described in more detail with respect to FIG. 4.

In some cases, the UE 115-a may initiate the procedure by transmitting a request 240 for a machine learning model to the AMF entity 205. In some cases, the UE 115-a may determine a machine learning model to request based on a function or operation performed at the UE 115-a. For example, if the UE 115-a is to perform network selection, the UE 115-a may request a machine learning model for network load to acquire the network load analytics. If the UE 115-a is performing an operation related to service experience, the UE 115-a may request a machine learning model for service experience.

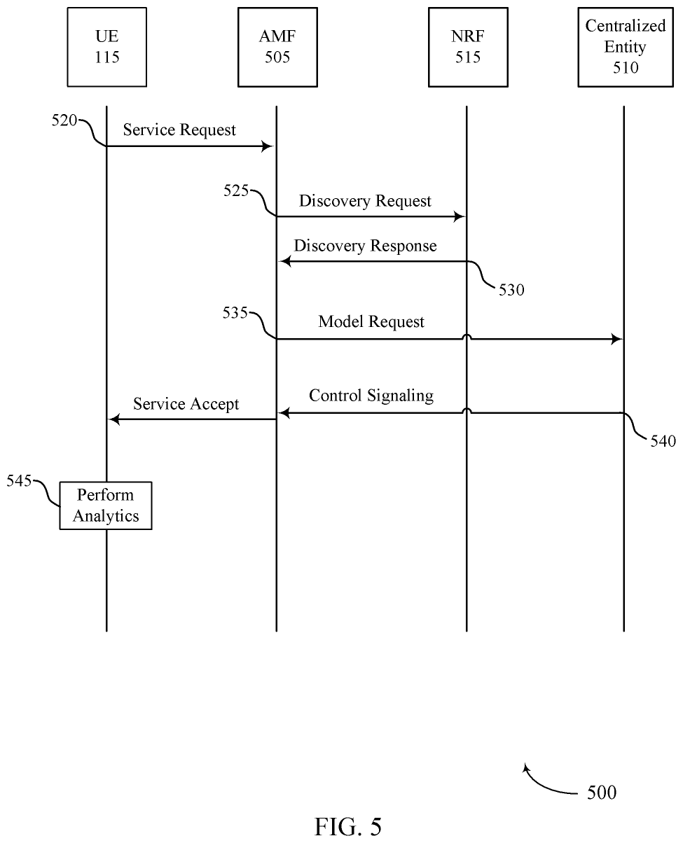

The AMF entity 205 may identify, or discover, a centralized core network entity which manages the requested machine learning model, such as the centralized core network entity 210, and the AMF entity 205 may send the request 240 to the centralized core network entity 210. The centralized core network entity 210 may send the machine learning model configuration 230 to configure the UE 115-a with the machine learning model to the AMF entity 205, and the AMF entity 205 may send the machine learning model configuration 230 (e.g., by forwarding a NAS message via the NAS signaling 250) to the UE 115-a to configure the UE 115-a with the machine learning model. In some cases, to discover the centralized core network entity 210, the AMF entity 205 may send a discovery request message to an NRF entity, and the NRF entity may send a discovery response message to the AMF entity 205, indicating or identifying the centralized core network entity 210. An example of a UE-initiated machine learning model configuration is described in more detail with respect to FIG. 5.

In some cases, the UE 115-a may obtain a machine learning model from the core network. For example, the UE 115-a may receive the machine learning model configuration 230, which may indicate the machine learning model. The machine learning model configuration 230 may include, for example, an address or location for the machine learning model (e.g., a URL or an FQDN), and the UE 115-a may obtain the machine learning model from the core network via the address or the location for the machine learning model. In some cases, the machine learning model configuration 230 may not directly provide the machine learning model to the UE 115-a, instead providing the stored machine learning model file address. The UE 115-a may download the machine learning model from the indicated address (e.g., via the user plane).

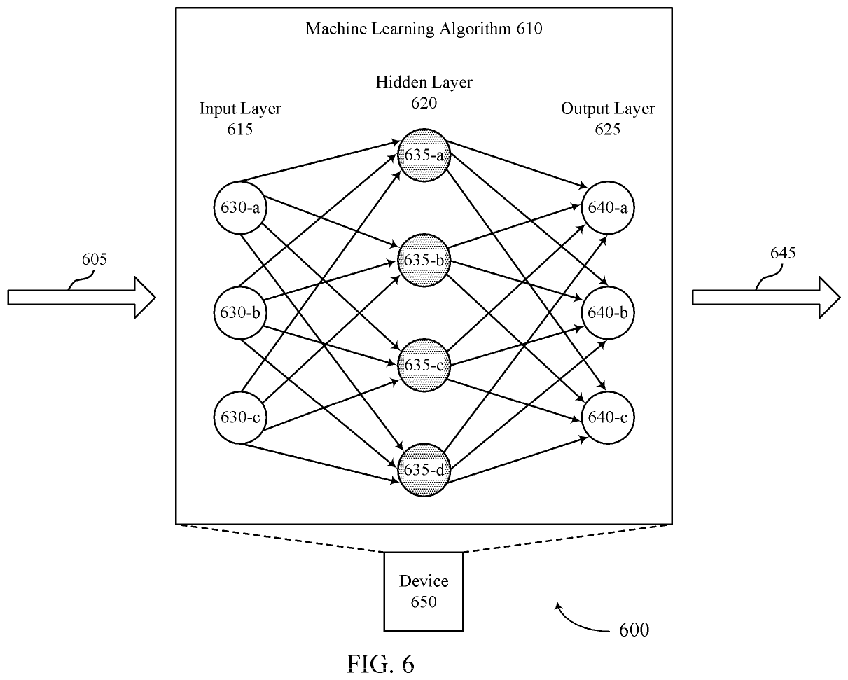

The UE 115-a may perform analytics based on the machine learning model. Performing the analytics may enable some optimizations at the UE 115-a or at the core network. For example, the UE 115-a may request to perform the analytics to achieve UE optimizations based on inferences determined from the machine learning model. Additionally, or alternatively, a core network entity may request for the UE 115-a to perform analytics and report information obtained from performing the analytics, which may enable optimizations at the core network or the core network entity based on the reported information. Some examples and techniques for using a machine learning model are described in more detail with reference to FIG. 6.

In some examples, the UE 115-a may report analytics, training information, or inferences determined based on the machine learning model. For example, the UE 115-a may transmit a report to one or more of the core network entities indicating the information. In some cases, the core network may use the reported information to perform optimizations at the core network. Additionally, or alternatively, the core network may update the machine learning model based on training performed by the UE 115-a. For example, the core network may request for the UE 115-a to send an analytics result or a trained machine learning model to the core network, and core network may use analytics result or trained machine learning model to optimize the core network operations.

FIG. 3 illustrates an example of a capability indication procedure 300 that supports centralized machine learning model configurations in accordance with aspects of the present disclosure.

The capability indication procedure 300 may be implemented by a UE 115, an AMF entity 305, or both. The UE 115 and the AMF entity 305 may be respective examples of a UE 115 and an AMF entity 205 as described with reference to FIG. 2. The processes and signaling of the capability indication procedure 300 are exemplary and may occur in different orders in other examples. In some cases, some additional signaling or procedures not shown may be performed, or some signaling or procedures shown may not be performed in other examples.

A machine learning model may require certain software, hardware, machine learning data training platform, or any combination thereof, to support an operation of the machine learning model at a UE 115. If a UE 115 supports a machine learning model, the UE 115 may have the associated software or hardware, or both. In some cases, to support an application layer machine learning model, the UE 115 may have a configuration authorization from application to an application client of the UE 115. Different UEs 115 may have different capabilities to support different machine learning models.

The UE 115 may indicate machine learning capability information to the AMF entity 305 to support a centralized machine learning model configuration. For example, the UE 115 may transmit, to the AMF entity 305 at 310, an indication of a first set of machine learning models supported at the UE 115. The UE 115 may send the capability to the AMF entity 305 to indicate a support or capability of the UE 115 receiving a machine learning model configuration from a centralized core network entity, which may manage machine learning and artificial intelligence operation in the core network. In some cases, an indication of supported machine learning models may include identifiers for the supported machine learning models. For example, the UE 115 may transmit, to the AMF entity 305 at 315, an indication of machine learning models which are supported at the UE 115. In some cases, the UE 115 may transmit a registration request including the indication of the UE capability. In response, the AMF entity 305 may transmit a registration response to the UE 115 at 320.

In some cases, the AMF entity 305 may manage or store which UEs 115 support certain machine learning models. For example, the AMF entity 305 may be requested to identify one or more UEs 115 which support a certain machine learning model. In some cases, the AMF entity 305 may indicate which machine learning models are supported by a UE 115 to another core network entity, such as an NRF or a centralized core network entity described herein. The NRF may be, for example, a network entity which is used to store and manage a network profile. The network profile may include a network supported function, served location area, served slice information, or any combination thereof, for network entities of the network.

FIG. 4 illustrates an example of a network-initiated machine learning model configuration 400 that supports centralized machine learning model configurations in accordance with aspects of the present disclosure.

The network-initiated machine learning model configuration 400 may be implemented by a UE 115, an AMF entity 405, a centralized core network entity 410, an NRF entity 415, another network entity 420, or any combination thereof. The UE 115, the AMF entity 405, and the centralized core network entity 410 may be respective examples of a UE 115, an AMF entity 205, a centralized core network entity 210, and an NRF entity as described with reference to FIG. 2. The other network entity 420 may be an example of another network entity, such as an SMF, a consumer, or the like. The processes and signaling of the network-initiated machine learning model configuration 400 are exemplary and may occur in different orders in other examples. In some cases, some additional signaling or procedures not shown may be performed, or some signaling or procedures shown may not be performed in other examples.

A UE 115 or a core network may initiate a procedure to configure the UE 115 with a machine learning model for performing analytics. The network-initiated machine learning model configuration 400 shows an example of the centralized core network entity 410 receiving an analytics request 425 from another network entity 420 to obtain analytics based on a machine learning model. The other network entity 420 may be, for example, the AMF entity 405, an SMF entity, a PCF entity, an OAM entity, or an application function entity, which may send an analytics request 425 for different uses. For example, the AMF entity 405 may request to know access UEs 115 in a specific registration area or specific network slice, such that the AMF entity 405 can adjust the network resource allocation for these registration area or the slice. In another example, an SMF entity may request information for the service experience of UEs 115 in a specific registration area or a specific network slice, such that the SMF entity can adjust the resource allocation for data transmission.

In some cases, the analytics request 425 may include an event filter, which may specify how to obtain the analytics based on the machine learning model. The analytics request 425 may request analytics for one or more specific registration area lists, one or more specific network slices, or both. Additionally, or alternatively, the analytics request 425 may indicate one or more specific UEs 115, a group of UEs 115, or both. In some cases, the analytics request 425 may include a SUPI for one or more UEs 115 or a group of UEs 115. In some examples, different analytics operations may correspond to different analytics identifiers. The analytics request 425 may include an analytics identifier corresponding to a requested analytics for one or more UEs 115 to perform, such as analytics identifiers corresponding to different service exchange operations or network load analysis operations.

In some cases, the centralized core network entity 410 may identify the UEs 115 to perform the analytics based on the machine learning model. The centralized core network entity 410 may determine to activate a machine learning mode in one or more UEs 115 to acquire the analytics. In some cases, the centralized core network entity 410 may identify the UEs 115 based on specific UE identifiers or UE group identifies included in the analytics request 425. Additionally, or alternatively, the centralized core network entity 410 may identify AMF entities which are in a network slice or registration area list identified by the analytics request 425, and the centralized core network entity 410 may request for the AMF entity 405 to indicate UEs 115 which support the requested machine learning model.

For example, the centralized core network entity 410 may identify one or more AMF entities which serve UEs 115 that support the requested machine learning model by communicating with the NRF entity 415. The centralized core network entity 410 may send a discover request 430, such as an Nnrf_AMFDiscover_Request, to the NRF entity 415. The discovery request 430 may indicate one or more registration area lists or one or more network slice identifiers based on the event filter received in the analytics request 425. In some cases, the centralized core network entity 410 may include a ratio or a number of AMF entities in the discovery request 430. In some examples, the centralized core network entity 410 may identify the served AMF entity 405 from a unified data management (UDM) entity. If the analytics request 425 includes a group identifier, the centralized core network entity 410 may determine a SUPI for the one or more UEs 115 from the UDM entity.

The NRF entity 415 may identify AMF entities based on the discovery request 430. In some cases, the NRF entity 415 may identify AMF entities that serve UEs 115 which support the requested machine learning model, or the NRF entity 415 may identify AMF entities associated with the indicated network slice or registration area list, or both. The NRF entity 415 may transmit a discovery response 435 to the centralized core network entity 410 indicating the identified AMF entities, including at least the AMF entity 405. The discovery response 435 may include AMF identifiers which serve the requested registration area lists, network slices, or both. If the discovery request 430 includes a ratio or number of AMF entities, the discovery response 435 may include the number or partial of AMF entities.

In some cases, the centralized core network entity 410 may send a subscriber request 440 to the one or more AMF entities, including the AMF entity 405. The subscriber request 440 may include a network slice identifier, registration area list, machine learning model identifier for the requested machine learning model, or any combination thereof. The centralized core network entity 410 may select a UE list based on a criteria, such as UEs 115 that support a certain machine learning model (e.g., to provide a requested type of analytics or inferences) or UEs 115 within a certain geographic area, registration area, or network slice. For example, the criteria may be that a UE 115 is registered in a specified registration area list, activate the specific slice, and the UE support the requested ML model.

In some cases, the subscriber request 440 may request for the AMF entity 405 to report UE identifiers for UEs 115 that support the requested machine learning model. The AMF entity 405 may transmit a subscriber notification 445 in response to the subscriber request 440. The subscriber notification 445 may include UE identifiers of one or more UEs 115 which support the requested machine learning model. In some cases, if the centralized core network entity 410 requests or provides partial UE information, the AMF entity 405 may select the UEs 115 to indicate in the subscriber notification 445. In some cases, Nafm_EventExposure_Subscribe may be an example of the subscriber request 440, and Namf_EventExposure_Notify may be an example of the subscriber notification 445.

The centralized core network entity 410 may send control signaling 450 to the identified one or more UEs 115, including the UE 115, to configure the machine learning model at the one or more UEs 115. The centralized core network entity 410 may transmit a NAS message, or a message with a container configured according to the centralized core network entity 410, to the UE 115. The control signaling 450 may include a machine learning model identifier for the requested machine learning model, a machine learning model file address, a version for the machine learning model, a time or duration for performing analytics according to the machine learning model, an event filter, a machine learning model training request, a machine learning model inference request, or any combination thereof.

The event filter may indicate when to activate the machine learning model, such as to activate the machine learning model after downloading the machine learning model, to activate the machine learning model in an indicated time interval, a machine learning model expiration time, or any combination thereof, among other event filters. The machine learning model file address may be, for example, a URL or an FQDN which the UE 115 may use to obtain or download the machine learning model from the core network. The machine learning model training request and the machine learning model inference request may indicate to the UE 115 how to use the machine learning model. For example, the machine learning model configuration information may request for the UE 115 to perform additional training on the machine learning model or for the UE 115 to perform inferences based on the machine learning model.

In some cases, the machine learning model configuration information may indicate an analytics identifier for an associated model. For example, the machine learning model configuration information may request for the UE 115 to perform a certain type of analytics, provide a certain type of information, inference, or analysis, or to perform a certain type of training using the model, or any combination thereof. The analytics identifier may be associated with the analytics request, where the machine learning model configuration includes a machine learning model file stored address, a validity time, the machine learning model identifier used to identify the machine learning model and the corresponding analytics identifier for this machine learning model. In some cases, the machine learning model configuration information may include a set of parameters for using the machine learning model. For example, the UE 115 may use the machine learning model based on the included set of parameters, performing analysis, inferences, or training based on the set of parameters.

In some cases, the centralized core network entity 410 may send the container or the message with the container to the AMF entity 405. By sending the machine learning model configuration in the message with the container, the machine learning model configuration may be transparent to the AMF entity 405. The AMF entity 405 may transmit or forward the container to the UE 115 via a NAS message. Based on the machine learning model configuration being sent via the NAS message, the AMF entity 405 may forward the machine learning model configuration to the UE 115 without knowing the information included in the NAS signaling. In some cases, the centralized core network entity 410 may transmit the control signaling 450 to the UE 115 via the AMF entity 405. For example, the centralized core network entity 410 may send the control signaling 450 in the container or message with the container to the AMF entity 405, and the AMF may forward the control signaling 450 to the UE 115 via the NAS message. The control signaling 450 may, for example, be NAS signaling including a machine learning model configuration. The NAS signaling may be forwarded from the AMF entity 405 to the UE 115, where the machine learning model configuration may be transparent to the AMF entity 405. The centralized core network entity 410 may send the control signaling 450 to the one or more UEs 115 identified by the analytics request 425, identified by the AMF entity 405, or identified by the centralized core network entity 410 based on the UE information provided by the AMF entity 405. In some cases, Namf_Communication_N1N2MessageSubscribe may be an example of the container or message with the container. In some examples, the AMF entity 405 may send a UE configuration update message to the UE 115 including the control signaling 450.

The UE 115 may receive the control signaling 450 that indicates a configuration for a machine learning model at the UE 115, the machine learning model included in a set of one or more machine learning models supported at the UE 115. The control signaling 450 may include the machine learning model information. In some cases, the UE 115 may obtain the machine learning model based on the machine learning model information. For example, the UE 115 may download the machine learning model from the core network based on an address or location included in the machine learning model configuration information. In some cases, the UE 115 may send a completion message or a message notification 455 to the AMF entity 405. In some cases, the completion message may be a NAS message, and the AMF entity may send the completion message to the centralized core network entity 410. In some examples, Namf_Communication_N1N2Message_Notif may be an example of the message notification 455. Additionally, or alternatively, the UE 115 may send a UE configuration update complete message to the AMF entity 405 including the message notification 455. In some examples, the AMF entity 405 may forward the message notification 455 to the centralized core network entity 410 transparently.

At 460, the UE 115 may perform analytics based on the machine learning model. For example, the UE 115 may perform inferences based on the machine learning model, train the machine learning model, or analyze network conditions based on the machine learning model. In some examples, the UE 115 may send a report of the analytics to the core network, such as by transmitting a report 465 to the AMF entity 405. In some cases, the AMF entity 405 may send the report to the centralized core network entity 410 or the other network entity 420, or both. The core network may, in some cases, perform core network optimizations based on the report.

FIG. 5 illustrates an example of a UE-initiated machine learning model configuration 500 that supports centralized machine learning model configurations in accordance with aspects of the present disclosure.

The UE-initiated machine learning model configuration 500 may be implemented by a UE 115, an AMF entity 505, a centralized core network entity 510, an NRF entity 515, or any combination thereof. The UE 115, the AMF entity 505, and the centralized core network entity 510 may be respective examples of a UE 115, an AMF entity 205, a centralized core network entity 210, and an NRF entity as described with reference to FIG. 2. The processes and signaling of the UE-initiated machine learning model configuration 500 are exemplary and may occur in different orders in other examples. In some cases, some additional signaling or procedures not shown may be performed, or some signaling or procedures shown may not be performed in other examples.

A UE 115 or a core network may initiate a procedure to configure the UE 115 with a machine learning model for performing analytics. The UE-initiated machine learning model configuration 500 shows an example of the UE 115 transmitting a request for the core network to provide information for a machine learning model. The UE 115 may transmit a request 520 to the AMF entity 505. The request 520 may be a NAS message. A service request message or a registration request message may be an example of the request 520. The request 520 may include an identifier of a request machine learning model. In some cases, the UE 115 may include a network slice identifier in the request 520.

The AMF entity 505 may identify a centralized core network entity that supports the requested machine learning model, such as the centralized core network entity 510, based on receiving the request 520. In some cases, the AMF entity 505 may identify the centralized core network entity 510 via the NRF entity 515. The AMF entity 505 may transmit a discovery request 525 to the NRF entity 515 to identify the centralized core network entity 510. The discovery request 525 may include a machine learning model identifier, a registration area, a network slice identifier, or any combination thereof. The NRF entity 515 may send a discovery response 530 to the AMF entity 505 in response. The discovery response 530 may include an identifier of the centralized core network entity 510.

The AMF entity 505 may forward the request 520 to the centralized core network entity 510 identified by the discovery response 530. For example, the AMF entity 505 may send a model request 535 to the centralized core network entity 510. The model request 535 may include the machine learning model identifier, a registration area identifier, a network slice identifier, or any combination thereof. In some cases, Nnf_EventExposure_Subscribe may be an example of the model request 535.

The centralized core network entity 510 may send control signaling 540 to the UE 115 including information for the machine learning model. The control signaling 540 may include the machine learning model identifier, a valid time for the machine learning model, a version for the machine learning model, a file address or location for the machine learning model, an event filter, or any combination thereof. In some cases, the centralized core network entity 510 may send the machine learning model information to the AMF entity 505, and the AMF may forward the machine learning model information to the UE 115 via a NAS message. In some cases, the AMF entity 505 may transmit a service accept message to the UE 115. The service accept message may, in some cases, include or be an example of the control signaling 540 or the NAS message, or both.

The UE 115 may receive the control signaling 540 that indicates a configuration for a machine learning model at the UE 115, the machine learning model included in a set of one or more machine learning models supported at the UE 115. The control signaling 540 may include the machine learning model information. In some cases, the UE 115 may obtain the machine learning model based on the machine learning model information. For example, the UE 115 may download the machine learning model from the core network based on an address or location included in the machine learning model configuration information.

At 545, the UE 115 may perform analytics based on the machine learning model. For example, the UE 115 may perform inferences based on the machine learning model, train the machine learning model, or analyze network conditions based on the machine learning model. In some cases, the UE 115 may perform UE-side optimizations based on the analytics.

FIG. 6 illustrates an example of a machine learning process 600 that supports centralized machine learning model configurations in accordance with aspects of the present disclosure. The machine learning process 600 may be implemented at a device 650, which may be an example of a core network entity, or a UE 115, or both as described with reference to FIGS. 1 through 5. In some examples, a UE 115 may perform techniques of the machine learning process 600 to perform analytics, inferences, or training based on a machine learning model. In some examples, the UE 115 may be configured with the machine learning model according to techniques described herein via a centralized core network entity, which may manage machine learning model functions within a core network.

The machine learning process 600 may include a machine learning algorithm 610. The machine learning algorithm 610 may be implemented by the device 650. As illustrated, the machine learning algorithm 610 may be an example of a neural network, such as a feed forward (FF) or deep feed forward (DFF) neural network, a recurrent neural network (RNN), a long/short term memory (LSTM) neural network, or any other type of neural network. However, any other machine learning algorithms may be supported. For example, the machine learning algorithm 610 may implement a nearest neighbor algorithm, a linear regression algorithm, a Naïve Bayes algorithm, a random forest algorithm, or any other machine learning algorithm. Furthermore, the machine learning process 600 may involve supervised learning, unsupervised learning, semi-supervised learning, reinforcement learning, or any combination thereof.

The machine learning algorithm 610 may include an input layer 615, one or more hidden layers 620, and an output layer 625. In a fully connected neural network with one hidden layer 620, each hidden layer node 635 may receive a value from each input layer node 630 as input, where each input may be weighted. These neural network weights may be based on a cost function that is revised during training of the machine learning algorithm 610. Similarly, each output layer node 640 may receive a value from each hidden layer node 635 as input, where the inputs are weighted. If post-deployment training (e.g., online training) is supported, memory may be allocated to store errors and/or gradients for reverse matrix multiplication. These errors and/or gradients may support updating the machine learning algorithm 610 based on output feedback. Training the machine learning algorithm 610 may support computation of the weights (e.g., connecting the input layer nodes 630 to the hidden layer nodes 635 and the hidden layer nodes 635 to the output layer nodes 640) to map an input pattern to a desired output outcome. This training may result in a device-specific machine learning algorithm 610 based on the historic application data and data transfer for a specific network entity 105 or UE 115.

In some examples, input values 605 may be sent to the machine learning algorithm 610 for processing. In some example, preprocessing may be performed according to a sequence of operations on the input values 605 such that the input values 605 may be in a format that is compatible with the machine learning algorithm 610. The input values 605 may be converted into a set of k input layer nodes 630 at the input layer 615. In some cases, different measurements may be input at different input layer nodes 630 of the input layer 615. Some input layer nodes 630 may be assigned default values (e.g., values of 0) if the number of input layer nodes 630 exceeds the number of inputs corresponding to the input values 605. As illustrated, the input layer 615 may include three input layer nodes 630-a, 630-b, and 630-c. However, it is to be understood that the input layer 615 may include any number of input layer nodes 630 (e.g., 20 input nodes).

The machine learning algorithm 610 may convert the input layer 615 to a hidden layer 620 based on a number of input-to-hidden weights between the k input layer nodes 630 and the n hidden layer nodes 635. The machine learning algorithm 610 may include any number of hidden layers 620 as intermediate steps between the input layer 615 and the output layer 625. Additionally, each hidden layer 620 may include any number of nodes. For example, as illustrated, the hidden layer 620 may include four hidden layer nodes 635-a, 635-b, 635-c, and 635-d. However, it is to be understood that the hidden layer 620 may include any number of hidden layer nodes 635 (e.g., 10 input nodes). In a fully connected neural network, each node in a layer may be based on each node in the previous layer. For example, the value of hidden layer node 635-a may be based on the values of input layer nodes 630-a, 630-b, and 630-c (e.g., with different weights applied to each node value).

The machine learning algorithm 610 may determine values for the output layer nodes 640 of the output layer 625 following one or more hidden layers 620. For example, the machine learning algorithm 610 may convert the hidden layer 620 to the output layer 625 based on a number of hidden-to-output weights between the n hidden layer nodes 635 and the m output layer nodes 640. In some cases, n=m. Each output layer node 640 may correspond to a different output value 645 of the machine learning algorithm 610. As illustrated, the machine learning algorithm 610 may include three output layer nodes 640-a, 640-b, and 640-c, supporting three different threshold values. However, it is to be understood that the output layer 625 may include any number of output layer nodes 640. In some examples, post-processing may be performed on the output values 645 according to a sequence of operations such that the output values 645 may be in a format that is compatible with reporting the output values 645.

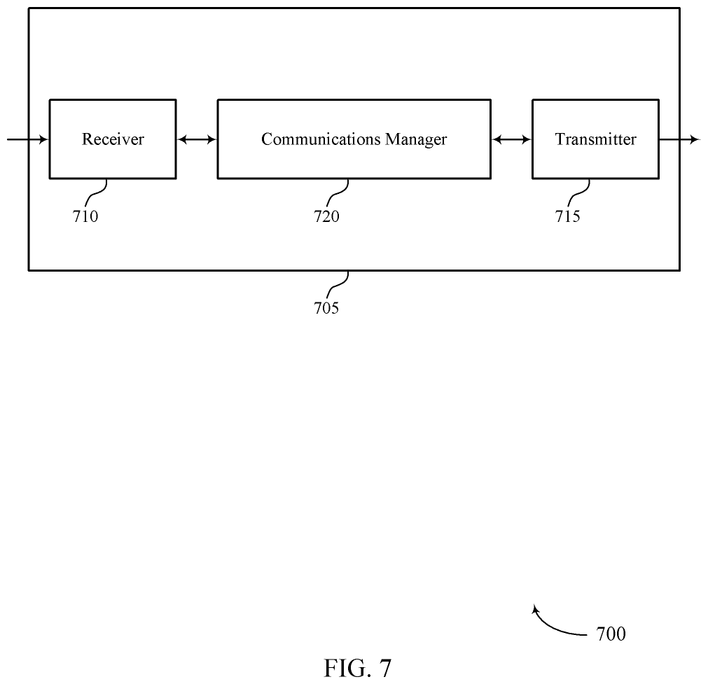

FIG. 7 shows a block diagram 700 of a device 705 that supports centralized machine learning model configurations in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to centralized machine learning model configurations). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to centralized machine learning model configurations). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of centralized machine learning model configurations as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 may be configured as or otherwise support a means for transmitting, to a first core network entity, an indication of a first set of one or more machine learning models supported at the UE. The communications manager 720 may be configured as or otherwise support a means for receiving, from the first core network entity, control signaling indicating a configuration for a machine learning model at the UE, the first set of one or more machine learning models including the machine learning model. The communications manager 720 may be configured as or otherwise support a means for performing analytics based on the machine learning model.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced power consumption by identifying optimizations at the device 705 based on performing inferences using a machine learning model.

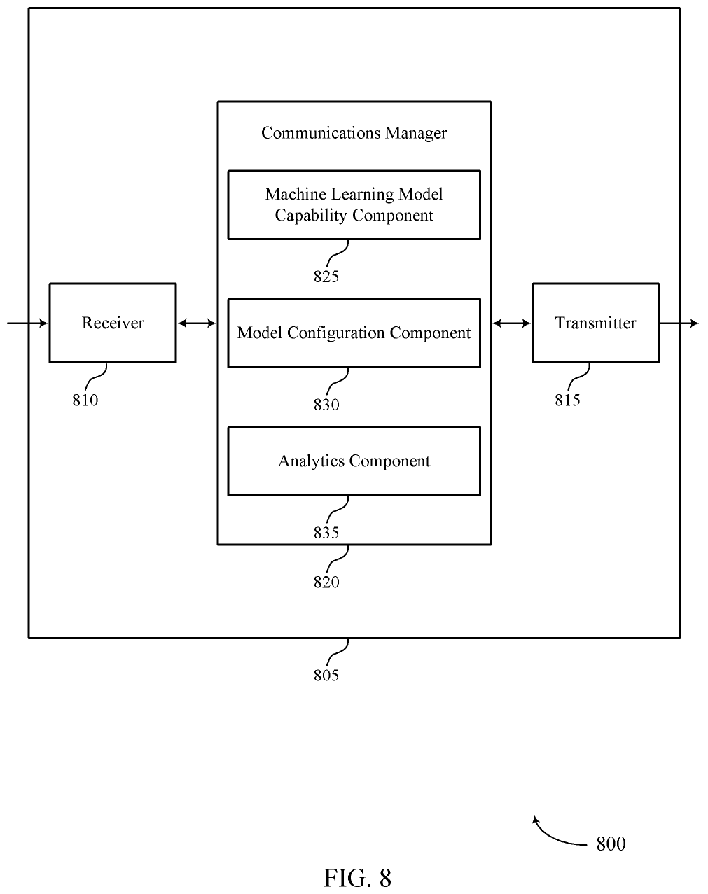

FIG. 8 shows a block diagram 800 of a device 805 that supports centralized machine learning model configurations in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to centralized machine learning model configurations). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to centralized machine learning model configurations). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of centralized machine learning model configurations as described herein. For example, the communications manager 820 may include a machine learning model capability component 825, a model configuration component 830, an analytics component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The machine learning model capability component 825 may be configured as or otherwise support a means for transmitting, to a first core network entity, an indication of a first set of one or more machine learning models supported at the UE. The model configuration component 830 may be configured as or otherwise support a means for receiving, from the first core network entity, control signaling indicating a configuration for a machine learning model at the UE, the first set of one or more machine learning models including the machine learning model. The analytics component 835 may be configured as or otherwise support a means for performing analytics based on the machine learning model.

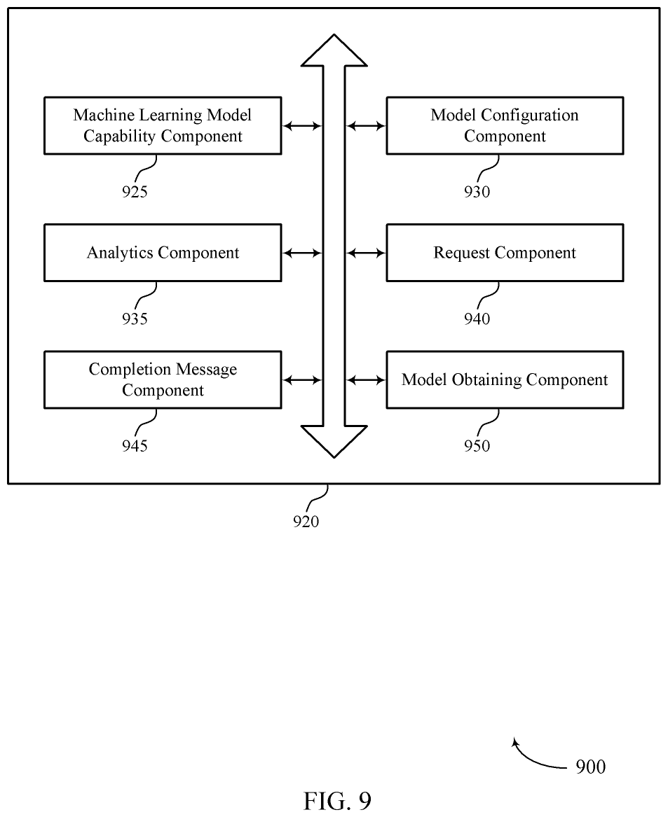

FIG. 9 shows a block diagram 900 of a communications manager 920 that supports centralized machine learning model configurations in accordance with one or more aspects of the present disclosure. The communications manager 920 may be an example of aspects of a communications manager 720, a communications manager 820, or both, as described herein. The communications manager 920, or various components thereof, may be an example of means for performing various aspects of centralized machine learning model configurations as described herein. For example, the communications manager 920 may include a machine learning model capability component 925, a model configuration component 930, an analytics component 935, a request component 940, a completion message component 945, a model obtaining component 950, or any combination thereof. Each of these components may communicate, directly or indirectly, with one another (e.g., via one or more buses).

The communications manager 920 may support wireless communications at a UE in accordance with examples as disclosed herein. The machine learning model capability component 925 may be configured as or otherwise support a means for transmitting, to a first core network entity, an indication of a first set of one or more machine learning models supported at the UE. The model configuration component 930 may be configured as or otherwise support a means for receiving, from the first core network entity, control signaling indicating a configuration for a machine learning model at the UE, the first set of one or more machine learning models including the machine learning model. The analytics component 935 may be configured as or otherwise support a means for performing analytics based on the machine learning model.

In some examples, the request component 940 may be configured as or otherwise support a means for transmitting, to the first core network entity, a request for the machine learning model. In some examples, the model configuration component 930 may be configured as or otherwise support a means for receiving the control signaling in response to the request.

In some examples, to support transmitting the request, the request component 940 may be configured as or otherwise support a means for transmitting a service request message. In some examples, to support transmitting the request, the model configuration component 930 may be configured as or otherwise support a means for receiving the control signaling via a service response message. In some examples, the request includes an identifier for the machine learning model, a network slice identifier, or both.

In some examples, the completion message component 945 may be configured as or otherwise support a means for transmitting, to the first core network entity, a completion message based on the control signaling indicating the configuration for the machine learning model at the UE.

In some examples, to support receiving the control signaling, the model configuration component 930 may be configured as or otherwise support a means for receiving the control signaling indicating the configuration for the machine learning model, the control signaling indicating a machine learning model file address, a machine learning model training request, a machine learning model inference request, a machine learning model identifier, a machine learning model location, a machine learning model version, a duration of time for performing the analytics, an activation event for reporting the analytics, or any combination thereof.

In some examples, to support receiving the control signaling, the model configuration component 930 may be configured as or otherwise support a means for receiving one or more parameters for the machine learning model. In some examples, to support receiving the control signaling, the analytics component 935 may be configured as or otherwise support a means for performing the analytics based on the one or more parameters.

In some examples, the model obtaining component 950 may be configured as or otherwise support a means for obtaining the machine learning model from a core network based on an address indicated via the control signaling. In some examples, the analytics component 935 may be configured as or otherwise support a means for transmitting a NAS message to the first core network entity including information determined from performing the analytics based on the machine learning model.

In some examples, to support receiving the control signaling, the model configuration component 930 may be configured as or otherwise support a means for receiving a NAS message that is configured according to a core network centralized entity container, the NAS message indicating the configuration for the machine learning model at the UE. In some examples, the first core network entity is an AMF entity.

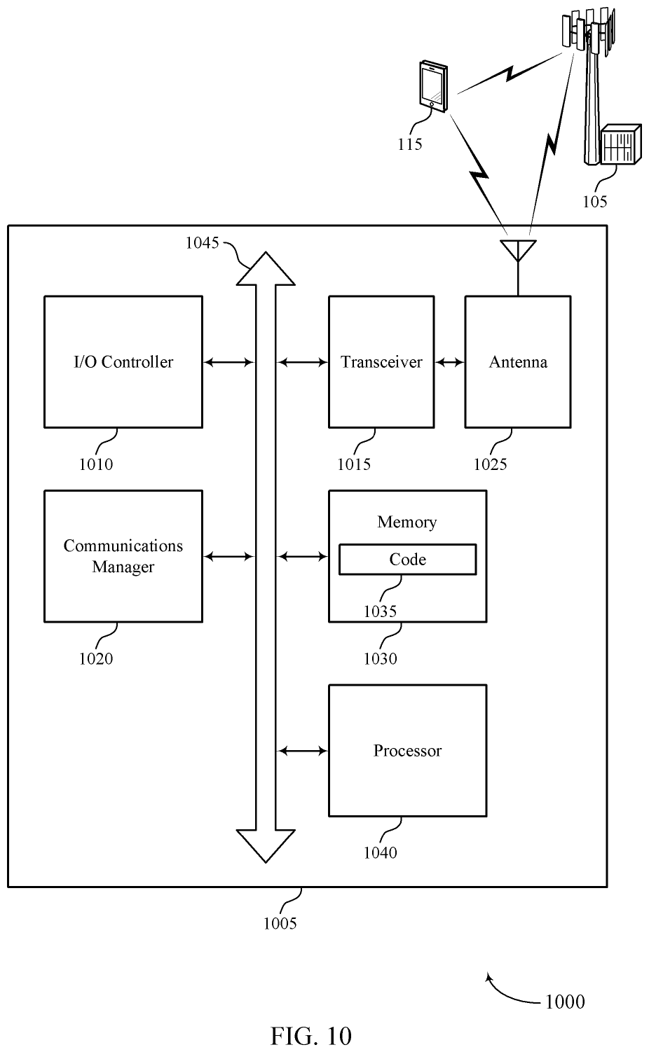

FIG. 10 shows a diagram of a system 1000 including a device 1005 that supports centralized machine learning model configurations in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting centralized machine learning model configurations). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a UE in accordance with examples as disclosed herein. For example, the communications manager 1020 may be configured as or otherwise support a means for transmitting, to a first core network entity, an indication of a first set of one or more machine learning models supported at the UE. The communications manager 1020 may be configured as or otherwise support a means for receiving, from the first core network entity, control signaling indicating a configuration for a machine learning model at the UE, the first set of one or more machine learning models including the machine learning model. The communications manager 1020 may be configured as or otherwise support a means for performing analytics based on the machine learning model.

By including or configuring the communications manager 1020 in accordance with examples as described herein, the device 1005 may support techniques for improved coordination between devices by identifying optimizations at a UE 115 or a core network, or both, based on the UE 115 performing inferences and analytics using a machine learning model.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of centralized machine learning model configurations as described herein, or the processor 1040 and the memory 1030 may be otherwise configured to perform or support such operations.

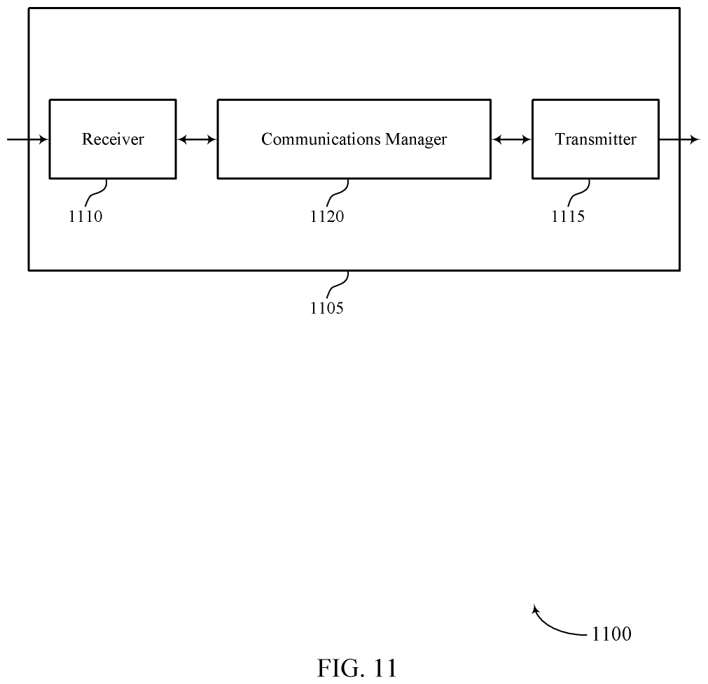

FIG. 11 shows a block diagram 1100 of a device 1105 that supports centralized machine learning model configurations in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of centralized machine learning model configurations as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 may be configured as or otherwise support a means for obtaining an indication of a first set of one or more machine learning models supported at a UE. The communications manager 1120 may be configured as or otherwise support a means for obtaining, from a second core network entity, control signaling configured according to the second core network entity, the control signaling indicating a configuration for a machine learning model from the first set of one or more machine learning models at the UE. The communications manager 1120 may be configured as or otherwise support a means for outputting a NAS message including the control signaling configured according to the second core network entity.

Additionally, or alternatively, the communications manager 1120 may support wireless communications at a second core network entity in accordance with examples as disclosed herein. For example, the communications manager 1120 may be configured as or otherwise support a means for identifying a UE that supports a machine learning model to be configured at the UE. The communications manager 1120 may be configured as or otherwise support a means for outputting, to a first core network entity, control signaling configured according to the second core network entity, the control signaling to indicate a configuration for the machine learning model to the UE.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced processing or more efficient utilization of communications resources based on inferences reported from a UE 115 determined based on a machine learning model.

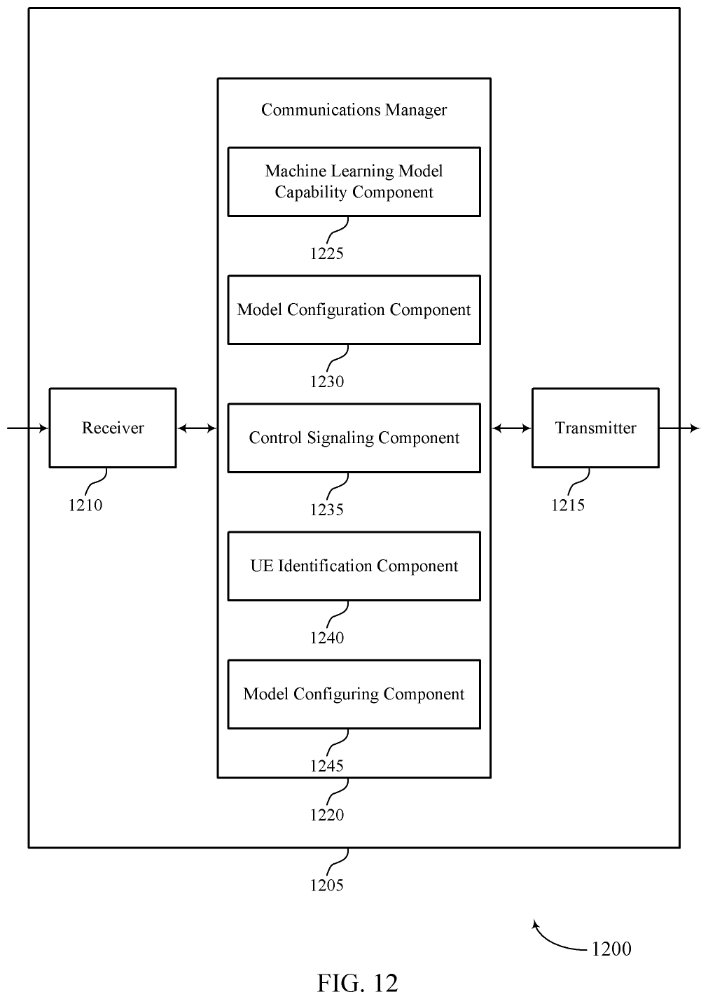

FIG. 12 shows a block diagram 1200 of a device 1205 that supports centralized machine learning model configurations in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of centralized machine learning model configurations as described herein. For example, the communications manager 1220 may include a machine learning model capability component 1225, a model configuration component 1230, a control signaling component 1235, a UE identification component 1240, a model configuring component 1245, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The machine learning model capability component 1225 may be configured as or otherwise support a means for obtaining an indication of a first set of one or more machine learning models supported at a UE. The model configuration component 1230 may be configured as or otherwise support a means for obtaining, from a second core network entity, control signaling configured according to the second core network entity, the control signaling indicating a configuration for a machine learning model from the first set of one or more machine learning models at the UE. The control signaling component 1235 may be configured as or otherwise support a means for outputting a NAS message including the control signaling configured according to the second core network entity.

Additionally, or alternatively, the communications manager 1220 may support wireless communications at a second core network entity in accordance with examples as disclosed herein. The UE identification component 1240 may be configured as or otherwise support a means for identifying a UE that supports a machine learning model to be configured at the UE. The model configuring component 1245 may be configured as or otherwise support a means for outputting, to a first core network entity, control signaling configured according to the second core network entity, the control signaling to indicate a configuration for the machine learning model to the UE.

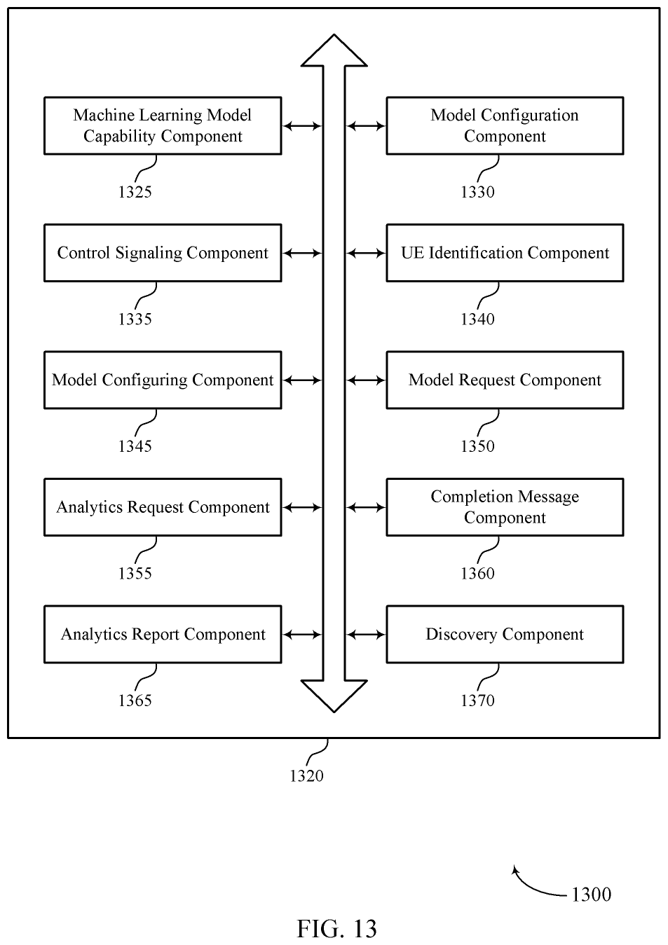

FIG. 13 shows a block diagram 1300 of a communications manager 1320 that supports centralized machine learning model configurations in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of centralized machine learning model configurations as described herein. For example, the communications manager 1320 may include a machine learning model capability component 1325, a model configuration component 1330, a control signaling component 1335, a UE identification component 1340, a model configuring component 1345, a model request component 1350, an analytics request component 1355, a completion message component 1360, an analytics report component 1365, and a discovery component 1370, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The machine learning model capability component 1325 may be configured as or otherwise support a means for obtaining an indication of a first set of one or more machine learning models supported at a UE. The model configuration component 1330 may be configured as or otherwise support a means for obtaining, from a second core network entity, control signaling configured according to the second core network entity, the control signaling indicating a configuration for a machine learning model from the first set of one or more machine learning models at the UE. The control signaling component 1335 may be configured as or otherwise support a means for outputting a NAS message including the control signaling configured according to the second core network entity.

In some examples, the model request component 1350 may be configured as or otherwise support a means for obtaining a request for the machine learning model. In some examples, the model request component 1350 may be configured as or otherwise support a means for outputting, to the second core network entity, an indication of the request for the machine learning model. In some examples, the model configuration component 1330 may be configured as or otherwise support a means for obtaining the control signaling based on the indication.

In some examples, the discovery component 1370 may be configured as or otherwise support a means for outputting, to a third core network entity, a discovery request for the second core network entity. In some examples, the discovery component 1370 may be configured as or otherwise support a means for obtaining, from the third core network entity, an identifier for the second core network entity based on the discovery request. In some examples, the request includes an identifier for the machine learning model, a network slice identifier, or both.

In some examples, the analytics request component 1355 may be configured as or otherwise support a means for obtaining, from the second core network entity, a request for one or more UEs to perform analytics based on the machine learning model. In some examples, the analytics request component 1355 may be configured as or otherwise support a means for outputting the NAS message to the UE based on the request.

In some examples, the analytics request component 1355 may be configured as or otherwise support a means for outputting, to the second core network entity, one or more identifiers for a set of one or more UEs associated with a first core network entity that support the machine learning model, the set of UEs including at least the UE. In some examples, the request for the one or more UEs to perform analytics includes one or more UE identifiers, one or more registration area lists, one or more network slice identifiers, or any combination thereof, associated with the one or more UEs.

In some examples, the analytics request component 1355 may be configured as or otherwise support a means for identifying the one or more UEs including at least the UE based on the request.

In some examples, to support outputting the control signaling, the model configuration component 1330 may be configured as or otherwise support a means for outputting the NAS message including the control signaling indicating a machine learning model file address, a machine learning model training request, a machine learning model inference request, a machine learning model identifier, a machine learning model location, a machine learning model version, a duration of time for performing analytics, an activation event for reporting the analytics, one or more parameters for the machine learning model, or any combination thereof.

In some examples, the completion message component 1360 may be configured as or otherwise support a means for obtaining a completion message in response to the NAS message. In some examples, the completion message component 1360 may be configured as or otherwise support a means for outputting the completion message to the second core network entity.

Additionally, or alternatively, the communications manager 1320 may support wireless communications at a second core network entity in accordance with examples as disclosed herein. The UE identification component 1340 may be configured as or otherwise support a means for identifying a UE that supports a machine learning model to be configured at the UE. The model configuring component 1345 may be configured as or otherwise support a means for outputting, to a first core network entity, control signaling configured according to the second core network entity, the control signaling to indicate a configuration for the machine learning model to the UE.

In some examples, the model request component 1350 may be configured as or otherwise support a means for obtaining, from the first core network entity, an indication of a request from the UE for the machine learning model. In some examples, the UE identification component 1340 may be configured as or otherwise support a means for identifying the UE based on the indication of the request. In some examples, to support obtaining the indication, the model request component 1350 may be configured as or otherwise support a means for obtaining a NAS message via the first core network entity, the NAS message including the request.

In some examples, the analytics request component 1355 may be configured as or otherwise support a means for obtaining, from another network entity, a request for one or more UEs to perform analytics based on the machine learning model. In some examples, to support identifying the UE, the discovery component 1370 may be configured as or otherwise support a means for outputting, to one or more network entities including at least the second core network entity, a request message for the one or more network entities to report UE identifiers for UEs that support the machine learning model. In some examples, to support identifying the UE, the discovery component 1370 may be configured as or otherwise support a means for obtaining, from at least the second core network entity, a response message indicating a set of UEs including at least the UE. In some examples, the request message includes one or more registration area lists, one or more network slice identifiers, an identifier for the machine learning model.

In some examples, the discovery component 1370 may be configured as or otherwise support a means for outputting, to a third core network entity, a discovery request for the one or more network entities, the discovery request including one or more registration area lists or one or more network slice identifiers, or both. In some examples, the discovery component 1370 may be configured as or otherwise support a means for obtaining, from the third core network entity, a discovery response message indicating the one or more network entities including at least the second core network entity, where the one or more network entities correspond to the one or more registration area lists or the one or more network slice identifiers, or both.

In some examples, the request for the one or more UEs to perform the analytics includes one or more UE identifiers for the one or more UEs, a UE group identifier, or both, where the UE is identified based on the request.

In some examples, to support outputting the control signaling, the model configuring component 1345 may be configured as or otherwise support a means for outputting the control signaling indicating a machine learning model file address, a machine learning model training request, a machine learning model inference request, a machine learning model identifier, a machine learning model location, a machine learning model version, a duration of time for performing analytics, an activation event for reporting the analytics, one or more parameters for the machine learning model, or any combination thereof.

In some examples, the analytics report component 1365 may be configured as or otherwise support a means for obtaining, via the first core network entity, a NAS message including information determined at the UE by performing analytics based on the machine learning model.

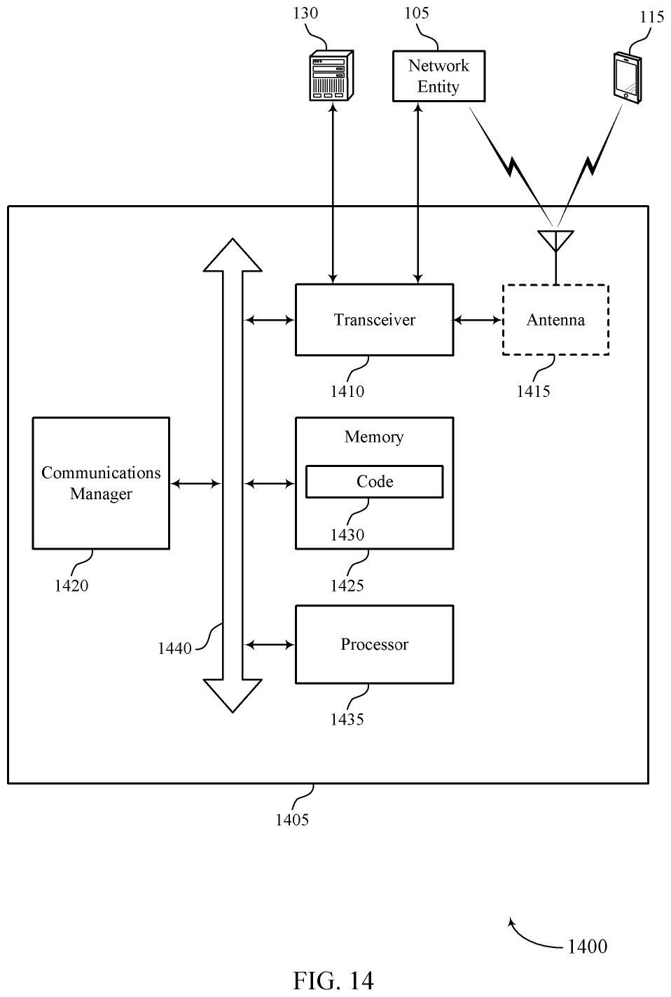

FIG. 14 shows a diagram of a system 1400 including a device 1405 that supports centralized machine learning model configurations in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting centralized machine learning model configurations). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 may be configured as or otherwise support a means for obtaining an indication of a first set of one or more machine learning models supported at a UE. The communications manager 1420 may be configured as or otherwise support a means for obtaining, from a second core network entity, control signaling configured according to the second core network entity, the control signaling indicating a configuration for a machine learning model from the first set of one or more machine learning models at the UE. The communications manager 1420 may be configured as or otherwise support a means for outputting a NAS message including the control signaling configured according to the second core network entity.

Additionally, or alternatively, the communications manager 1420 may support wireless communications at a second core network entity in accordance with examples as disclosed herein. For example, the communications manager 1420 may be configured as or otherwise support a means for identifying a UE that supports a machine learning model to be configured at the UE. The communications manager 1420 may be configured as or otherwise support a means for outputting, to a first core network entity, control signaling configured according to the second core network entity, the control signaling to indicate a configuration for the machine learning model to the UE.

By including or configuring the communications manager 1420 in accordance with examples as described herein, the device 1405 may support techniques for improved coordination between devices by identifying optimizations at a UE 115 or a core network, or both, based on the UE 115 performing inferences or analytics using a machine learning model.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of centralized machine learning model configurations as described herein, or the processor 1435 and the memory 1425 may be otherwise configured to perform or support such operations.

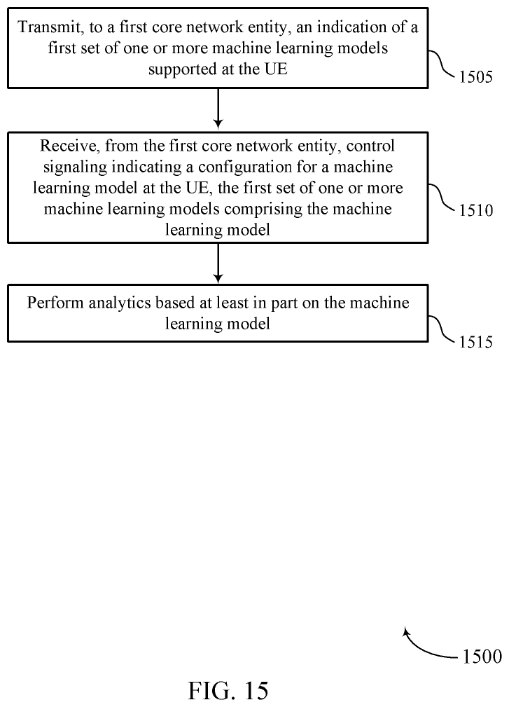

FIG. 15 shows a flowchart illustrating a method 1500 that supports centralized machine learning model configurations in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting, to a first core network entity, an indication of a first set of one or more machine learning models supported at the UE. The operations of 1505 may be performed in accordance with examples as disclosed herein. In some examples, aspects of the operations of 1505 may be performed by a machine learning model capability component 925 as described with reference to FIG. 9.

At 1510, the method may include receiving, from the first core network entity, control signaling indicating a configuration for a machine learning model at the UE, the first set of one or more machine learning models including the machine learning model. The operations of 1510 may be performed in accordance with examples as disclosed herein. In some examples, aspects of the operations of 1510 may be performed by a model configuration component 930 as described with reference to FIG. 9.

At 1515, the method may include performing analytics based on the machine learning model. The operations of 1515 may be performed in accordance with examples as disclosed herein. In some examples, aspects of the operations of 1515 may be performed by an analytics component 935 as described with reference to FIG. 9.

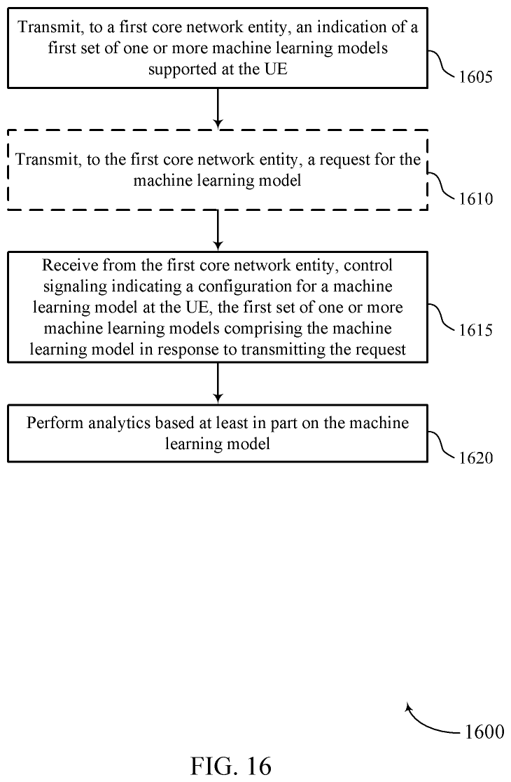

FIG. 16 shows a flowchart illustrating a method 1600 that supports centralized machine learning model configurations in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting, to a first core network entity, an indication of a first set of one or more machine learning models supported at the UE. The operations of 1605 may be performed in accordance with examples as disclosed herein. In some examples, aspects of the operations of 1605 may be performed by a machine learning model capability component 925 as described with reference to FIG. 9.

At 1610, the method may include transmitting, to the first core network entity, a request for the machine learning model. The operations of 1610 may be performed in accordance with examples as disclosed herein. In some examples, aspects of the operations of 1610 may be performed by a request component 940 as described with reference to FIG. 9.

At 1615, the method may include receiving the control signaling in response to transmitting the request. The operations of 1615 may be performed in accordance with examples as disclosed herein. In some examples, aspects of the operations of 1615 may be performed by a model configuration component 930 as described with reference to FIG. 9.

At 1620, the method may include receiving, from the first core network entity, control signaling indicating a configuration for a machine learning model at the UE, the first set of one or more machine learning models including the machine learning model. The operations of 1620 may be performed in accordance with examples as disclosed herein. In some examples, aspects of the operations of 1620 may be performed by a model configuration component 930 as described with reference to FIG. 9.

At 1625, the method may include performing analytics based on the machine learning model. The operations of 1625 may be performed in accordance with examples as disclosed herein. In some examples, aspects of the operations of 1625 may be performed by an analytics component 935 as described with reference to FIG. 9.

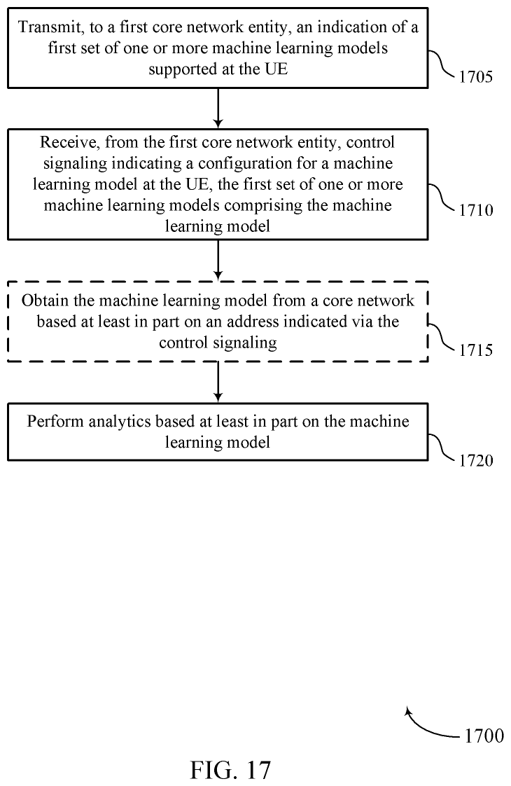

FIG. 17 shows a flowchart illustrating a method 1700 that supports centralized machine learning model configurations in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting, to a first core network entity, an indication of a first set of one or more machine learning models supported at the UE. The operations of 1705 may be performed in accordance with examples as disclosed herein. In some examples, aspects of the operations of 1705 may be performed by a machine learning model capability component 925 as described with reference to FIG. 9.

At 1710, the method may include receiving, from the first core network entity, control signaling indicating a configuration for a machine learning model at the UE, the first set of one or more machine learning models including the machine learning model. The operations of 1710 may be performed in accordance with examples as disclosed herein. In some examples, aspects of the operations of 1710 may be performed by a model configuration component 930 as described with reference to FIG. 9.

At 1715, the method may include obtaining the machine learning model from a core network based on an address indicated via the control signaling. The operations of 1715 may be performed in accordance with examples as disclosed herein. In some examples, aspects of the operations of 1715 may be performed by a model obtaining component 950 as described with reference to FIG. 9.

At 1720, the method may include performing analytics based on the machine learning model. The operations of 1720 may be performed in accordance with examples as disclosed herein. In some examples, aspects of the operations of 1720 may be performed by an analytics component 935 as described with reference to FIG. 9.

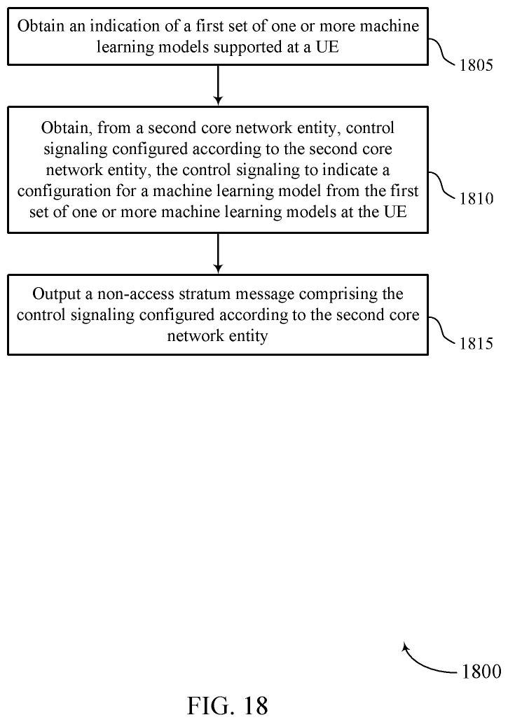

FIG. 18 shows a flowchart illustrating a method 1800 that supports centralized machine learning model configurations in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include obtaining an indication of a first set of one or more machine learning models supported at a UE. The operations of 1805 may be performed in accordance with examples as disclosed herein. In some examples, aspects of the operations of 1805 may be performed by a machine learning model capability component 1325 as described with reference to FIG. 13.

At 1810, the method may include obtaining, from a second core network entity, control signaling configured according to the second core network entity, the control signaling indicating a configuration for a machine learning model from the first set of one or more machine learning models at the UE. The operations of 1810 may be performed in accordance with examples as disclosed herein. In some examples, aspects of the operations of 1810 may be performed by a model configuration component 1330 as described with reference to FIG. 13.

At 1815, the method may include outputting a non-access stratum message including the control signaling configured according to the second core network entity. The operations of 1815 may be performed in accordance with examples as disclosed herein. In some examples, aspects of the operations of 1815 may be performed by a control signaling component 1335 as described with reference to FIG. 13.

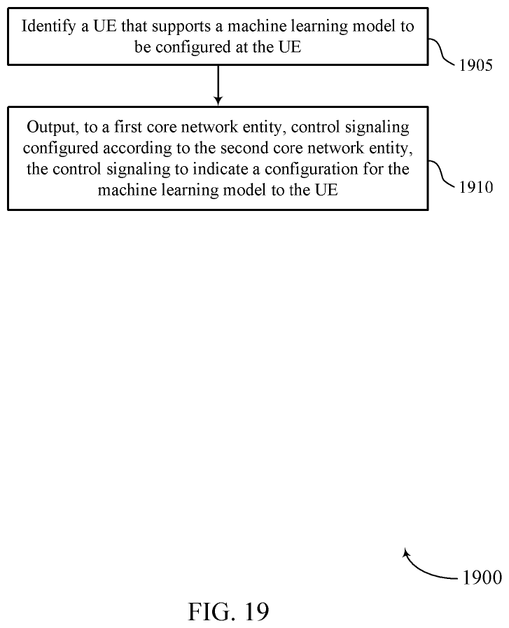

FIG. 19 shows a flowchart illustrating a method 1900 that supports centralized machine learning model configurations in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include identifying a UE that supports a machine learning model to be configured at the UE. The operations of 1905 may be performed in accordance with examples as disclosed herein. In some examples, aspects of the operations of 1905 may be performed by a UE identification component 1340 as described with reference to FIG. 13.

At 1910, the method may include outputting, to a first core network entity, control signaling configured according to the second core network entity, the control signaling to indicate a configuration for the machine learning model to the UE. The operations of 1910 may be performed in accordance with examples as disclosed herein. In some examples, aspects of the operations of 1910 may be performed by a model configuring component 1345 as described with reference to FIG. 13.

The following provides an overview of aspects of the present disclosure:

Aspect 1: A method for wireless communications at a UE, comprising: transmitting, to a first core network entity, an indication of a first set of one or more machine learning models supported at the UE; receiving, from the first core network entity, control signaling indicating a configuration for a machine learning model at the UE, the first set of one or more machine learning models comprising the machine learning model; and performing analytics based at least in part on the machine learning model.

Aspect 2: The method of aspect 1, further comprising: transmitting, to the first core network entity, a request for the machine learning model, wherein receiving the control signaling comprises: receiving the control signaling in response to transmitting the request.

Aspect 3: The method of aspect 2, wherein transmitting the request comprises: transmitting a service request message, wherein receiving the control signaling comprises: receiving the control signaling via a service response message

Aspect 4: The method of any of aspects 2 through 3, wherein the request comprises an identifier for the machine learning model, a network slice identifier, or both.

Aspect 5: The method of any of aspects 1 through 4, further comprising: transmitting, to the first core network entity, a completion message based at least in part on the control signaling indicating the configuration for the machine learning model at the UE.

Aspect 6: The method of any of aspects 1 through 5, wherein receiving the control signaling comprises: receiving the control signaling indicating the configuration for the machine learning model, the control signaling indicating a machine learning model file address, a machine learning model training request, a machine learning model inference request, a machine learning model identifier, a machine learning model location, a machine learning model version, a duration of time for performing the analytics, an activation event for reporting the analytics, or any combination thereof.

Aspect 7: The method of any of aspects 1 through 6, wherein receiving the control signaling comprises: receiving one or more parameters for the machine learning model; and wherein performing the analytics comprises: performing the analytics based at least in part on the one or more parameters.

Aspect 8: The method of any of aspects 1 through 7, further comprising: obtaining the machine learning model from a core network based at least in part on an address indicated via the control signaling.

Aspect 9: The method of any of aspects 1 through 8, further comprising: transmitting a non-access stratum message to the first core network entity comprising information determined from performing the analytics based at least in part on the machine learning model.

Aspect 10: The method of any of aspects 1 through 9, wherein receiving the control signaling comprises: receiving a non-access stratum message that is configured according to a core network centralized entity container, the non-access stratum message indicating the configuration for the machine learning model at the UE.

Aspect 11: The method of any of aspects 1 through 10, wherein the first core network entity is an access and mobility management function (AMF) entity.

Aspect 12: A method for wireless communications, comprising: obtaining an indication of a first set of one or more machine learning models supported at a UE; obtaining, from a second core network entity, control signaling configured according to the second core network entity, the control signaling indicating a configuration for a machine learning model from the first set of one or more machine learning models at the UE; outputting a non-access stratum message comprising the control signaling configured according to the second core network entity.

Aspect 13: The method of aspect 12, further comprising: obtaining a request for the machine learning model; outputting, to the second core network entity, an indication of the request for the machine learning model; and wherein obtaining the control signaling comprises: obtaining the control signaling based at least in part on the indication.

Aspect 14: The method of aspect 13, further comprising: outputting, to a third core network entity, a discovery request for the second core network entity; and obtaining, from the third core network entity, an identifier for the second core network entity based at least in part on the discovery request.

Aspect 15: The method of any of aspects 13 through 14, wherein the request comprises an identifier for the machine learning model, a network slice identifier, or both.

Aspect 16: The method of any of aspects 12 through 15, further comprising: obtaining, from the second core network entity, a request for one or more UEs to perform analytics based at least in part on the machine learning model; and wherein outputting the non-access stratum message comprises: outputting the non-access stratum message to the UE based at least in part on the request.

Aspect 17: The method of aspect 16, further comprising: outputting, to the second core network entity, one or more identifiers for a set of one or more UEs associated with a first core network entity that support the machine learning model, the set of UEs comprising at least the UE.

Aspect 18: The method of any of aspects 16 through 17, wherein the request for the one or more UEs to perform analytics comprises one or more UE identifiers, one or more registration area lists, one or more network slice identifiers, or any combination thereof, associated with the one or more UEs.

Aspect 19: The method of any of aspects 16 through 18, further comprising: identifying the one or more UEs comprising at least the UE based at least in part on the request.

Aspect 20: The method of any of aspects 12 through 19, wherein outputting the control signaling comprises: outputting the non-access stratum message comprising the control signaling indicating a machine learning model file address, a machine learning model training request, a machine learning model inference request, a machine learning model identifier, a machine learning model location, a machine learning model version, a duration of time for performing analytics, an activation event for reporting the analytics, one or more parameters for the machine learning model, or any combination thereof.

Aspect 21: The method of any of aspects 12 through 20, further comprising: obtaining a completion message in response to the non-access stratum message; and outputting the completion message to the second core network entity.

Aspect 22: A method for wireless communications at a second core network entity, comprising: identifying a UE that supports a machine learning model to be configured at the UE; and outputting, to a first core network entity, control signaling configured according to the second core network entity, the control signaling to indicate a configuration for the machine learning model to the UE.

Aspect 23: The method of aspect 22, further comprising: obtaining, from the first core network entity, an indication of a request from the UE for the machine learning model, wherein the UE is identified based at least in part on the indication of the request.

Aspect 24: The method of aspect 23, wherein obtaining the indication comprises: obtaining a non-access stratum message via the first core network entity, the non-access stratum message comprising the request.

Aspect 25: The method of any of aspects 22 through 24, further comprising: obtaining, from another network entity, a request for one or more UEs to perform analytics based at least in part on the machine learning model.

Aspect 26: The method of aspect 25, wherein identifying the UE comprises: outputting, to one or more network entities comprising at least the second core network entity, a request message for the one or more network entities to report UE identifiers for UEs that support the machine learning model; and obtaining, from at least the second core network entity, a response message indicating a set of UEs comprising at least the UE.

Aspect 27: The method of aspect 26, wherein the request message comprises one or more registration area lists, one or more network slice identifiers, an identifier for the machine learning model.

Aspect 28: The method of any of aspects 26 through 27, further comprising: outputting, to a third core network entity, a discovery request for the one or more network entities, the discovery request comprising one or more registration area lists or one or more network slice identifiers, or both; and obtaining, from the third core network entity, a discovery response message indicating the one or more network entities comprising at least the second core network entity, wherein the one or more network entities correspond to the one or more registration area lists or the one or more network slice identifiers, or both.

Aspect 29: The method of any of aspects 25 through 28, wherein the request for the one or more UEs to perform the analytics comprises one or more UE identifiers for the one or more UEs, a UE group identifier, or both, wherein the UE is identified based at least in part on the request.

Aspect 30: The method of any of aspects 22 through 29, wherein outputting the control signaling comprises: outputting the control signaling indicating a machine learning model file address, a machine learning model training request, a machine learning model inference request, a machine learning model identifier, a machine learning model location, a machine learning model version, a duration of time for performing analytics, an activation event for reporting the analytics, one or more parameters for the machine learning model, or any combination thereof.

Aspect 31: The method of any of aspects 22 through 30, further comprising: obtaining, via the first core network entity, a non-access stratum message comprising information determined at the UE by performing analytics based at least in part on the machine learning model.

Aspect 32: An apparatus for wireless communications at a UE, comprising a processor; and memory coupled to the processor, the processor configured to perform a method of any of aspects 1 through 11.

Aspect 33: An apparatus for wireless communications at a UE, comprising at least one means for performing a method of any of aspects 1 through 11.

Aspect 34: A non-transitory computer-readable medium storing code for wireless communications at a UE, the code comprising instructions executable by a processor to perform a method of any of aspects 1 through 11.

Aspect 35: An apparatus for wireless communications, comprising a processor; and memory coupled to the processor, the processor configured to perform a method of any of aspects 12 through 21.

Aspect 36: An apparatus for wireless communications, comprising at least one means for performing a method of any of aspects 12 through 21.

Aspect 37: A non-transitory computer-readable medium storing code for wireless communications, the code comprising instructions executable by a processor to perform a method of any of aspects 12 through 21.

Aspect 38: An apparatus for wireless communications at a second core network entity, comprising a processor; and memory coupled to the processor, the processor configured to perform a method of any of aspects 22 through 31.

Aspect 39: An apparatus for wireless communications at a second core network entity, comprising at least one means for performing a method of any of aspects 22 through 31.

Aspect 40: A non-transitory computer-readable medium storing code for wireless communications at a second core network entity, the code comprising instructions executable by a processor to perform a method of any of aspects 22 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor; and
memory coupled to the processor, the processor configured to:
transmit, to a first core network entity, an indication of a first set of one or more machine learning models supported at the UE;
receive, from the first core network entity, control signaling indicating a configuration for a machine learning model at the UE, the first set of one or more machine learning models comprising the machine learning model; and
perform analytics based at least in part on the machine learning model.

2. The apparatus of claim 1, wherein the processor is further configured to:
transmit, to the first core network entity, a request for the machine learning model; and wherein, to receive the control signaling, the processor is configured to:
receive the control signaling in response to the request.

3. The apparatus of claim 2, wherein, to transmit the request, processor is configured to:
transmit a service request message; and wherein, to receive the control signaling, the processor is configured to:
receive the control signaling via a service response message.

4. The apparatus of claim 2, wherein the request comprises an identifier for the machine learning model, a network slice identifier, or both.

5. The apparatus of claim 1, wherein the processor is further configured to:
transmit, to the first core network entity, a completion message based at least in part on the control signaling indicating the configuration for the machine learning model at the UE.

6. The apparatus of claim 1, wherein, to receive the control signaling, the processor is configured to:
receive the control signaling indicating the configuration for the machine learning model, the control signaling indicating a machine learning model file address, a machine learning model training request, a machine learning model inference request, a machine learning model identifier, a machine learning model location, a machine learning model version, a duration of time for performing the analytics, an activation event for reporting the analytics, or any combination thereof.

7. The apparatus of claim 1, wherein, to receive the control signaling, the processor is configured to:
receive one or more parameters for the machine learning model; and
wherein, to perform the analytics, the processor is configured to:
perform the analytics based at least in part on the one or more parameters.

8. The apparatus of claim 1, wherein the processor is further configured to:
obtain the machine learning model from a core network based at least in part on an address indicated via the control signaling.

9. The apparatus of claim 1, wherein the processor is further configured to:
transmit a non-access stratum message to the first core network entity comprising information determined from performing the analytics based at least in part on the machine learning model.

10. The apparatus of claim 1, wherein, to receive the control signaling, the processor is configured to:
receive a non-access stratum message that is configured according to a core network centralized entity container, the non-access stratum message indicating the configuration for the machine learning model at the UE.

11. The apparatus of claim 1, wherein the first core network entity is an access and mobility management function (AMF) entity.

12. An apparatus for wireless communications, comprising:
a processor; and
memory coupled to the processor, the processor configured to:
obtain an indication of a first set of one or more machine learning models supported at a user equipment (UE);
obtain, from a second core network entity, control signaling configured according to the second core network entity, the control signaling indicating a configuration for a machine learning model from the first set of one or more machine learning models; and
output a non-access stratum message comprising the control signaling configured according to the second core network entity.

13. The apparatus of claim 12, wherein the processor is further configured to:
obtain a request for the machine learning model; and
output, to the second core network entity, an indication of the request for the machine learning model; and wherein, to obtain the control signaling, the processor is further configured to:
obtain the control signaling based at least in part on the indication.

14. The apparatus of claim 13, wherein the processor is further configured to:
output, to a third core network entity, a discovery request for the second core network entity; and
obtain, from the third core network entity, an identifier for the second core network entity based at least in part on the discovery request.

15. The apparatus of claim 13, wherein the request comprises an identifier for the machine learning model, a network slice identifier, or both.

16. The apparatus of claim 12, wherein the processor is further configured to:
obtain, from the second core network entity, a request for one or more UEs to perform analytics based at least in part on the machine learning model; and wherein, to output the non-access stratum message, the processor is further configured to:
output the non-access stratum message based at least in part on the request.

17. The apparatus of claim 16, wherein the processor is further configured to:
output, to the second core network entity, one or more identifiers for a set of one or more UEs that support the machine learning model, the set of one or more UEs comprising at least the UE.

18. The apparatus of claim 16, wherein the request for the one or more UEs to perform analytics comprises one or more UE identifiers, one or more registration area lists, one or more network slice identifiers, or any combination thereof, associated with the one or more UEs.

19. The apparatus of claim 16, wherein the processor is further configured to:
identify the one or more UEs comprising at least the UE based at least in part on the request.

20. The apparatus of claim 12, wherein, to output the control signaling, the processor is configured to:
output the non-access stratum message comprising the control signaling indicating a machine learning model file address, a machine learning model training request, a machine learning model inference request, a machine learning model identifier, a machine learning model location, a machine learning model version, a duration of time for performing analytics, an activation event for reporting the analytics, one or more parameters for the machine learning model, or any combination thereof.

21. The apparatus of claim 12, wherein the processor is further configured to:
obtain a completion message in response to the non-access stratum message; and
output the completion message to the second core network entity.

22. An apparatus for wireless communications at a second core network entity, comprising:
a processor; and
memory coupled to the processor, the processor configured to:
identify a user equipment (UE) that supports a machine learning model to be configured at the UE; and
output, to a first core network entity, control signaling configured according to the second core network entity, the control signaling to indicate a configuration for the machine learning model to the UE.

23. The apparatus of claim 22, wherein the processor is further configured to:
obtain, from the first core network entity, an indication of a request from the UE for the machine learning model to be configured at the UE; and wherein, to identify the UE, the processor is further configured to:
identify the UE based at least in part on the indication of the request.

24. The apparatus of claim 23, wherein, to obtain the indication, the processor is configured to:
obtain a non-access stratum message from the UE via the first core network entity, the non-access stratum message comprising the request.

25. The apparatus of claim 22, wherein the processor is further configured to:
obtain, from another network entity, a request for one or more UEs to perform analytics based at least in part on the machine learning model.

26. The apparatus of claim 25, wherein, to identify the UE, the processor is configured to:
output, to one or more network entities comprising at least the second core network entity, a request message for the one or more network entities to report UE identifiers for UEs that support the machine learning model; and
obtain, from at least the second core network entity, a response message indicating a set of UEs comprising at least the UE.

27. The apparatus of claim 26, wherein the processor is further configured to:
output, to a third core network entity, a discovery request for the one or more network entities, the discovery request comprising one or more registration area lists or one or more network slice identifiers, or both; and
obtain, from the third core network entity, a discovery response message indicating the one or more network entities comprising at least the second core network entity, wherein the one or more network entities correspond to the one or more registration area lists or the one or more network slice identifiers, or both.

28. The apparatus of claim 22, wherein, to output the control signaling, the processor is configured to:
output the control signaling indicating a machine learning model file address, a machine learning model training request, a machine learning model inference request, a machine learning model identifier, a machine learning model location, a machine learning model version, a duration of time for performing analytics, an activation event for reporting the analytics, one or more parameters for the machine learning model, or any combination thereof.

29. The apparatus of claim 22, wherein the processor is further configured to:
obtain, from the UE via the first core network entity, a non-access stratum message comprising information determined at the UE by performing analytics based at least in part on the machine learning model.

30. A method for wireless communications at a user equipment (UE), comprising:
transmitting, to a first core network entity, an indication of a first set of one or more machine learning models supported at the UE;
receiving, from the first core network entity, control signaling indicating a configuration for a machine learning model at the UE, the first set of one or more machine learning models comprising the machine learning model; and
performing analytics based at least in part on the machine learning model.
